(19) United States
(12) Patent Application Publication
(10) Pub. No.: US 2026/0029629 A1
(43) Pub. Date: Jan. 29, 2026

(54) ZOOM LENS AND IMAGE PICKUP APPARATUS

(71) Applicant: CANON KABUSHIKI KAISHA, Tokyo (JP)

(72) Inventor: Yuki SHINZATO, Saitama (JP)

(21) Appl. No.: 19/271,858

(22) Filed: Jul. 17, 2025

(30) Foreign Application Priority Data
Jul. 24, 2024 (JP) 2024-118487
Apr. 22, 2025 (JP) 2025-070523

(51) Int. Cl. G02B 15/14

(52) U.S. Cl. CPC G02B 15/1451

(57) ABSTRACT

A zoom lens includes, in order from an object side to an image side, a first lens unit with negative refractive power, an intermediate group with positive refractive power as a whole, and a subsequent group with negative refractive power as a whole. The intermediate group includes a first intermediate lens unit with positive refractive power, and a second intermediate lens unit with positive refractive power adjacent to and disposed on the image side of the first intermediate lens unit. During zooming, the first lens unit is stationary, and the first intermediate lens unit and the second intermediate lens unit move, and each distance between adjacent lens units changes. The first lens unit includes two or more lenses. Predetermined inequalities are satisfied.

### BACKGROUND

### Field of the Technology

The present disclosure relates to a zoom lens for imaging.

### Description of the Related Art

It is known to configure a zoom lens to drive a lens unit as a variator using an actuator.

### SUMMARY

A zoom lens according to one aspect of the disclosure includes, in order from an object side to an image side, a first lens unit with negative refractive power, an intermediate group with positive refractive power as a whole, and a subsequent group with negative refractive power as a whole. The intermediate group includes a first intermediate lens unit with positive refractive power, and a second intermediate lens unit with positive refractive power adjacent to and disposed on the image side of the first intermediate lens unit. During zooming, the first lens unit is stationary, and the first intermediate lens unit and the second intermediate lens unit move, and each distance between adjacent lens units changes. The first lens unit includes two or more lenses. The following inequalities are satisfied:

$$0.10 \leq \vert mp 2 / mp 1 \vert \leq 0.82$$

$$1.23 \leq fp 2 / fp 1 \leq 10.$$

$$1. 50 \leq ft / fw \leq 6.00$$

$$0.1 \leq TTLw / fw \leq 10.00$$

where mp1 is a moving amount of the first intermediate lens unit during zooming from a wide-angle end to a telephoto end, mp2 is a moving amount of the second intermediate lens unit during zooming from the wide-angle end to the telephoto end, fp1 is a focal length of the first intermediate lens unit, fp2 is a focal length of the second intermediate lens unit, fw is a focal length of the zoom lens at the wide-angle end, ft is a focal length of the zoom lens at the telephoto end, and TTLw is a sum of a distance on an optical axis from a lens surface closest to an object of the zoom lens at the wide-angle end to a lens surface closest to an image plane of the zoom lens at the wide-angle end and an air-equivalent distance on the optical axis from a lens surface closest to the image plane of the zoom lens to the image plane.

A zoom lens according to another aspect of the disclosure includes, in order from an object side to an image side, a first lens unit with negative refractive power, an intermediate group with positive refractive power as a whole, and a subsequent group with negative refractive power as a whole. The intermediate group includes a first intermediate lens unit with positive refractive power, and a second intermediate lens unit with positive refractive power adjacent to and disposed on the image side of the first intermediate lens unit. During zooming, the first lens unit is stationary, the first intermediate lens unit and the second intermediate lens unit move, and each distance between adjacent lens units changes. The first lens unit includes three or more lenses. The following inequality is satisfied:

$$1.5 \leq ft / fw \leq 6.00$$

where fw is a focal length of the zoom lens at a wide-angle end, and ft is a focal length of the zoom lens at a telephoto end.

A zoom lens according to another aspect of the disclosure includes, in order from an object side to an image side, a first lens unit with negative refractive power, an intermediate group with positive refractive power as a whole, and a subsequent group with negative refractive power as a whole. The intermediate group includes a first intermediate lens unit with positive refractive power, and a second intermediate lens unit with positive refractive power adjacent to and disposed on the image side of the first intermediate lens unit. During zooming, the first lens unit is stationary, and the first intermediate lens unit and the second intermediate lens unit move, and each distance between adjacent lens units changes. The first lens unit includes two or more lens elements. The following inequalities are satisfied:

$$0.10 \leq \vert mp 2 / mp 1 \vert \leq 0.82$$

$$1.23 \leq fp 2 / fp 1 \leq 10.$$

$$1. 50 \leq ft / fw \leq 6.00$$

$$0.1 \leq TTLw / fw \leq 10.00$$

where mp1 is a moving amount of the first intermediate lens unit during zooming from a wide-angle end to a telephoto end, mp2 is a moving amount of the second intermediate lens unit during zooming from the wide-angle end to the telephoto end, fp1 is a focal length of the first intermediate lens unit, fp2 is a focal length of the second intermediate lens unit, fw is a focal length of the zoom lens at the wide-angle end, ft is a focal length of the zoom lens at the telephoto end, and TTLw is a sum of a distance on an optical axis from a lens surface closest to an object of the zoom lens at the wide-angle end to a lens surface closest to an image plane of the zoom lens at the wide-angle end and an air-equivalent distance on the optical axis from a lens surface closest to the image plane of the zoom lens to the image plane.

An image pickup apparatus having any one of the above zoom lenses also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 illustrates sectional views of a zoom lens according to Example 1 at a wide-angle end, an intermediate zoom position, and a telephoto end.

FIGS. 2A, 2B, and 2C illustrate aberration diagrams of the zoom lens according to Example 1 at the wide-angle end, the intermediate zoom position, and the telephoto end.

FIG. 3 illustrates sectional views of a zoom lens according to Example 2 at a wide-angle end, an intermediate zoom position, and a telephoto end.

FIGS. 4A, 4B, and 4C illustrate aberration diagrams of the zoom lens according to Example 2 at the wide-angle end, the intermediate zoom position, and the telephoto end.

FIG. 5 illustrates sectional views of a zoom lens according to Example 3 at a wide-angle end, an intermediate zoom position, and a telephoto end.

FIGS. 6A, 6B, and 6C illustrate aberration diagrams of the zoom lens according to Example 3 at the wide-angle end, the intermediate zoom position, and the telephoto end.

FIG. 7 illustrates sectional views of a zoom lens according to Example 4 at a wide-angle end, an intermediate zoom position, and a telephoto end.

FIGS. 8A, 8B, and 8C are aberration diagrams of the zoom lens according to Example 4 at the wide-angle end, the intermediate zoom position, and the telephoto end.

FIG. 9 illustrates sectional views of a zoom lens according to Example 5 at a wide-angle end, an intermediate zoom position, and a telephoto end.

FIGS. 10A, 10B, and 10C are aberration diagrams of the zoom lens according to Example 5 at the wide-angle end, the intermediate zoom position, and the telephoto end.

FIG. 11 illustrates sectional views of a zoom lens according to Example 6 at a wide-angle end, an intermediate zoom position, and a telephoto end.

FIGS. 12A, 12B, and 12C are aberration diagrams of the zoom lens according to Example 6 at the wide-angle end, the intermediate zoom position, and the telephoto end.

FIG. 13 illustrates sectional views of a zoom lens according to Example 7 at a wide-angle end, an intermediate zoom position, and a telephoto end.

FIGS. 14A, 14B, and 14C are aberration diagrams of the zoom lens according to Example 7 at the wide-angle end, the intermediate zoom position, and the telephoto end.

FIG. 15 is a schematic diagram of an image pickup apparatus according to this embodiment.

### DESCRIPTION OF THE EMBODIMENTS

Referring now to the accompanying drawings, a detailed description will be given of embodiments according to the disclosure.

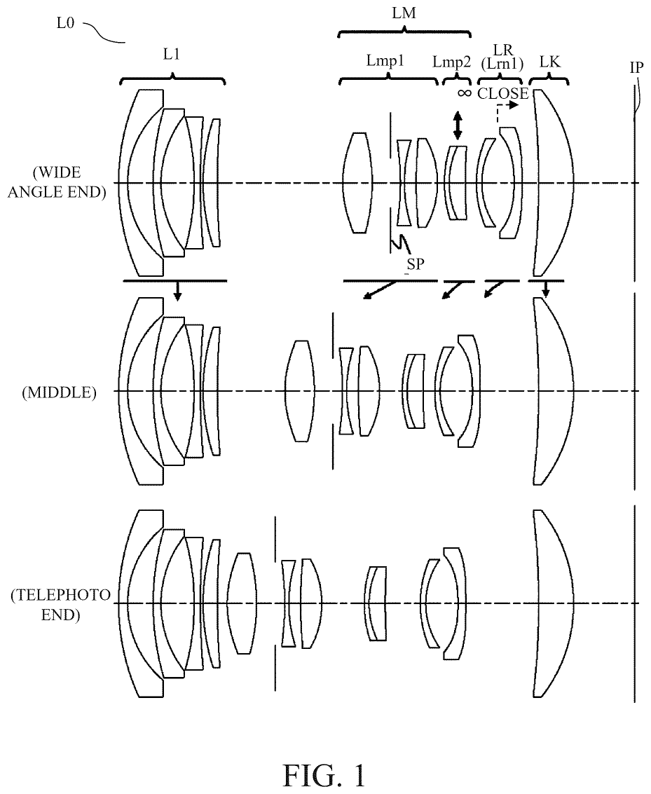

Before the zoom lenses according to Examples 1 to 7 are specifically discussed, matters common to each example will be discussed. FIGS. 1, 3, 5, 7, 9, 11, and 13 illustrate sections of zoom lenses according to Examples 1 to 7 at a wide-angle end, an intermediate zoom position, and a telephoto end, respectively. In each figure, a left side is an object side (front side), and a right side is an image side (rear side).

In a zoom lens, a lens unit is a group of one or more lenses that may or may not move as a unit during zooming and focusing between the wide-angle end and the telephoto end. In other words, each distance between adjacent lens units changes during zooming and focusing. The lens unit may include an aperture stop. The wide-angle end and the telephoto end respectively indicate the zoom states of the maximum angle of view (shortest focal length) and the minimum angle of view (longest focal length) when the lens unit that moves during zooming is located at both ends of a mechanically or controllably movable range on the optical axis.

In a zoom lens, a lens element is a single lens component with refractive power, such as a single lens or a cemented lens. Therefore, a cemented lens formed by cementing two or more lenses is counted as one lens element.

The zoom lens according to each example is used for various image pickup apparatuses, such as digital video cameras, digital still cameras, broadcasting cameras, film-based cameras, surveillance cameras, and on-board (vehicle-mounted) cameras. The zoom lens according to each example can also be used as a projection lens for an image projection apparatus (projector) that projects an image displayed on a display element onto a projection surface such as a screen. In this case, a left side of the figure is a projection surface side, and a right side is a display element side.

The zoom lens L0 according to each example includes, in order from the object side to the image side, a first lens unit L1 with negative refractive power, an intermediate group LM with positive refractive power as a whole, and a subsequent group LR with negative refractive power as a whole. The phrase “as a whole” is used herein to define that the average refractive power of each of the lenses which make up the lens group is positive (e.g., the sum of each constituent lens of the lens group results in a positive refractive power value). For example, the lens group may include a first lens with a negative refractive power, but the negative refractive power of the first lens may be offset by a second lens of the lens group which has a positive refractive power value that is larger (i.e., greater in magnitude) than the negative refractive power value of the first lens. Hence, the refractive power value of the lens group is positive as a whole. The term “lens group” is used herein to define a plurality of lenses. The lens group may include at least one lens unit which defines a plurality of lenses (i.e., a subgroup of lenses within the lens group).

The intermediate group LM includes a first intermediate lens unit Lmp1 with positive refractive power and a second intermediate lens unit Lmp2 with positive refractive power adjacent to and disposed on the image side of the first intermediate lens unit Lmp1. The subsequent group LR is adjacent to and disposed on the image side of the second intermediate lens unit Lmp2. The zoom lens L0 according to each example has a reduced size as a whole, a high magnification-varying ratio, and high optical performance, and reduces the sizes, weights, and moving amounts of the lens units configured to move during zooming.

In each figure, an arrow is used below a lens unit that moves during zooming to illustrate a moving trajectory during zooming from the wide-angle end to the telephoto end. A dotted arrow is used above the lens unit that moves during focusing to illustrate a moving direction during focusing from infinity to a close distance. An arrow is used above an image stabilizing lens unit that moves in a direction orthogonal to the optical axis for image stabilization to illustrate a moving direction.

In each figure, SP represents an aperture stop that determines a light beam of a full aperture F-number (Fno), and IP represents an image plane. An imaging surface (light receiving surface) of an image sensor such as a CCD sensor or a CMOS sensor, or a film surface (photosensitive surface) of a silver film is disposed on the image plane IP.

The zoom lens L0 according to each example is designed to allow for the occurrence of distortion. This is because it is assumed that the distortion of the optical image that occurs on the image plane IP due to distortion will be corrected by performing image processing for the image data obtained by the image sensor. For example, an image pickup apparatus that performs imaging through the zoom lens L0 according to each example corrects the acquired image data by image processing using information on a distortion amount of the zoom lens L0.

In the zoom lens L0 according to each example, the first lens unit L1 does not move (is fixed) relative to the image plane IP during zooming. Since the lenses included in the first lens unit L1 have a large outer diameter, the weight of the first lens unit L is likely to increase. Thus, keeping the first lens unit L1 stationary during zooming can realize fast and quiet zooming. Keeping the first lens unit L1 stationary during zooming can suppress the tilt of the first lens unit L1 that occurs during zooming, and improve optical performance.

In the zoom lens L0 according to each example, a first intermediate lens unit Lmp1 and a second intermediate lens unit Lmp2 move toward the object side during zooming from the wide-angle end to the telephoto end. Zooming is performed by moving the first intermediate lens unit Lmp1 with positive refractive power, and the second intermediate lens unit Lmp2 with positive refractive power, closer to the first lens unit L1 with negative refractive power. During zooming from the wide-angle end to the telephoto end, the second intermediate lens unit Lmp2 moves toward the object side while increasing a distance between it and the first intermediate lens unit Lmp1. Thereby, the moving amount and the size of the second intermediate lens unit Lmp2 can be reduced while the curvature of field is corrected. As a result, the load on the actuator that electrically drives the second intermediate lens unit Lmp2 can be reduced, and fast and quiet zooming can be achieved.

In the zoom lens L0 according to each example, the second intermediate lens unit Lmp2 may be an image stabilizing lens unit. Reducing the size and weight of the second intermediate lens unit Lmp2 as an image stabilizing lens unit can effectively correct image blur while suppressing the drive load during zooming.

In the zoom lens L0 according to each example, the first lens unit L1 includes two or more lenses including at least one negative lens and at least one positive lens, thereby effectively correcting aberrations. Effectively correcting off-axis aberrations (such as chromatic aberration and curvature of field) that occur in the first lens unit L1 that does not move during zooming can reduce the number of lenses for aberration correction in the intermediate group LM and the subsequent group LR that move during zooming. As a result, the lens units that move during zooming are made smaller and lighter. From the viewpoint of chromatic aberration correction, one positive lens may be disposed closest to the image plane in the first lens unit L1.

Next follows a description of conditions that may be satisfied by the zoom lens L0 according to each example. The zoom lens L0 according to each example may satisfy at least one of the following inequalities (1) to (4):

$$0.10 \leq \vert mp 2 / mp 1 \vert \leq 0.82 \qquad ( 1 )$$

$$1.23 \leq fp 2 / fp 1 \leq 10. \qquad ( 2 )$$

$$1. 50 \leq ft / fw \leq 6.00 \qquad ( 3 )$$

$$0.1 \leq TTLw / fw \leq 10.00 \qquad ( 4 )$$

In inequalities (1) to (4), mp1 is a moving amount of the first intermediate lens unit Lmp1 during zooming from the wide-angle end to the telephoto end, and mp2 is a moving amount of the second intermediate lens unit Lmp2 during zooming from the wide-angle end to the telephoto end. A moving amount of a lens unit is a difference between the position of the lens unit at the wide-angle end and the position of the lens unit at the telephoto end, not including the reciprocating moving amount, and is positive when the lens unit is located closer to the image side at the telephoto end than at the wide-angle end. fp1 is a focal length of the first intermediate lens unit Lmp1, fp2 is a focal length of the second intermediate lens unit Lmp2, fw is a focal length of the zoom lens L0 system at the wide-angle end, and ft is a focal length of the zoom lens L0 system at the telephoto end. TTLw is a sum of a distance on the optical axis from a lens surface closest to the object of the zoom lens L0 to a lens surface closest to the image plane of the zoom lens L0 at the wide-angle end and an air-equivalent distance on the optical axis from the lens surface closest to the image plane of the zoom lens L0 to the image plane (overall optical length).

Inequality (1) defines a proper relationship between the moving amounts of the first intermediate lens unit Lmp1 and the second intermediate lens unit Lmp2 during zooming from the wide-angle end to the telephoto end. In a case where |mp2/mp1| becomes higher than the upper limit of inequality (1), the moving amount of the second intermediate lens unit Lmp2 increases and the suppression of aberration fluctuations such as curvature of field becomes insufficient. In a case where |mp2/mp1| becomes lower than the lower limit of inequality (1), the moving amount of the second intermediate lens unit Lmp2 for high magnification variation cannot be sufficiently secured or the moving amount of the first intermediate lens unit Lmp1 increases.

The lower limit of inequality (1) may be set to 0.30, 0.50 or 0.60. The upper limit of inequality (1) may be set to 0.81, 0.80 or 0.795.

Inequality (2) defines a proper relationship between the focal lengths of the first intermediate lens unit Lmp1 and the second intermediate lens unit Lmp2. In a case where fp2/fp1 becomes higher than the upper limit of inequality (2), the refractive power of the first intermediate lens unit Lmp1 increases, and it becomes difficult to perform good aberration correction, or the refractive power of the second intermediate lens unit Lmp2 reduces, and the moving amount during zooming increases. In a case where fp2/fp1 becomes lower than the lower limit of inequality (2), the refractive power of the first intermediate lens unit Lmp1 reduces, and the moving amount during zooming increases, or the refractive power of the second intermediate lens unit Lmp2 increases, and it becomes difficult to perform good aberration correction.

The lower limit of inequality (2) may be set to 1.40, 1.60, 1.80, or 2.00. The upper limit of inequality (2) may be set to 8.00, 6.00, 4.00, or 3.00.

Inequality (3) defines a proper magnification-varying ratio for the zoom lens L0. In a case where ft/fw becomes higher than the upper limit of inequality (3), the magnification-varying ratio increases, and it becomes difficult to suppress aberration variation due to zooming across the entire zoom range. In a case where ft/fw becomes lower than the lower limit of inequality (3), the necessary high magnification variation cannot be achieved.

The lower limit of inequality (3) may be set to 1.75, 1.85, 1.95, or 2.00. The upper limit of inequality (3) may be set to 4.50, 4.00, 3.50, or 3.00.

Inequality (4) defines a proper relationship between the overall optical length of the zoom lens L0 at the wide-angle end and the focal length of the zoom lens L0. In a case where TTLw/fw becomes higher than the upper limit of inequality (4), the size of the zoom lens L0 increases. In a case where TTLw/fw becomes lower than the lower limit of inequality (4), it becomes difficult to secure sufficient space to place lenses for sufficient aberration correction.

The lower limit of inequality (4) may be 1.00, 1.50, 2.50, 3.50, or 4.50. The upper limit of inequality (4) may be 9.00, 8.50, 8.00, or 7.50.

The zoom lens L0 according to each example may satisfy at least one of the following configurations.

The first lens unit L1 in the zoom lens L0 according to each example may include, in order from the object side to the image side, two meniscus lenses that have negative refractive power and are convex toward the object side. These two meniscus lenses may be configured as two lens elements. Thereby, the zoom lens L0 may have higher magnification variation toward the wide-angle side while satisfactorily correcting off-axis aberrations such as curvature of field.

The first intermediate lens unit Lmp1 may include an aperture stop SP. Thereby, the size and weight of the movable lens units such as the first intermediate lens unit Lmp1 and the second intermediate lens unit Lmp2 disposed near the aperture stop SP can be reduced. This reduces the load on the actuator used to electrically drive the lens units during zooming, while allowing the lens unit to be provided with a plurality of lenses for aberration correction, thereby achieving good aberration performance over the entire zoom range with high magnification variation.

The first intermediate lens unit Lmp1 may include a single aspheric lens with an aspheric surface and positive refractive power whose refractive power weakens from the vicinity of the optical axis toward the periphery. Thereby, the overall length of the zoom lens L0 can be reduced, and spherical aberration, coma, and the like that occur particularly at the telephoto end can be satisfactorily corrected.

All of the first intermediate lens unit Lmp1, the second intermediate lens unit Lmp2, and the subsequent group LR may move toward the object side during zooming from the wide-angle end to the telephoto end. Thereby, aberration fluctuations due to zooming can be effectively suppressed and high magnification variation can be achieved.

The second intermediate lens unit Lmp2 may include a cemented lens in which one positive lens and one negative lens are cemented together. Thereby, chromatic aberrations occurring in the second intermediate lens unit Lmp2 can be suppressed, and as a result, chromatic aberration fluctuations due to zooming can be suppressed.

The subsequent group LR with negative refractive power as a whole may be disposed adjacent to and disposed on the image side of the intermediate group LM with positive refractive power as a whole. All lens units included in the subsequent group LR may have negative refractive power (that is, the subsequent group LR includes only lens units with negative refractive power). Providing such a telephoto type power arrangement can reduce the overall length and the size of the zoom lens L0.

The subsequent group LR may include two or more lenses. In this case, one cemented lens including two lenses cemented together is counted as two lenses. The subsequent group LR may include two or more lens elements. A biconvex air lens may be formed between two adjacent lenses or two lens elements. This configuration can suppress the variation of a variety of aberrations such as spherical aberration and curvature of field that occur in the subsequent group LR during zooming. The lens surface on the object side of the lens disposed closest to the object in the subsequent group LR may have a convex shape toward the object side. Thereby, the variation of spherical aberration that occurs during zooming can be suppressed. The lens element closest to the object in the subsequent group LR may have negative refractive power and a meniscus shape that is convex toward the object side.

All lenses included in the subsequent group LR may be moved toward the image side during focusing from infinity to a close distance (i.e., the subsequent group LR may be used as a focus unit). Thereby, focusing may be performed with suppressed variation of a variety of aberrations such as spherical aberration and curvature of field.

A final lens unit Lk with positive refractive power that does not move (or is fixed) during zooming may be disposed closest to the image plane of the zoom lens L0. For example, in a case where the zoom lens L0 is used as an electric zoom lens for a lens interchangeable type camera, the robustness of the zoom lens L0 can be improved by disposing the fixed final lens unit Lk closest to the image plane to prevent direct access to the movable lens unit from the outside. Disposing the final lens unit Lk with positive refractive power closest to the image plane can reduce an incident angle of off-axis light rays on the imaging surface of the image sensor, thereby suppressing shading that occurs in a peripheral part of an image.

The zoom lens L0 according to each example may satisfy at least one of the following inequalities (5) to (10):

$$0.73 \leq ( - frw ) / fpl \leq 2 \text{.04} \qquad ( 5 )$$

$$0.71 \leq fat / ft \leq 1.52 \qquad ( 6 )$$

$$0.46 \leq BFw / fw \leq 1.44 \qquad ( 7 )$$

$$0.54 \leq ( - f 1 ) / fp 1 \leq 2.29 \qquad ( 8 )$$

$$0.32 \leq \vert mn 1 / mp 1 \vert \leq 0. 77 \qquad ( 9 )$$

$$1.45 \leq Nave \leq 1.8 \qquad ( 10 )$$

In inequalities (5) to (10), frw is a combined focal length of the subsequent group LR at the wide-angle end, and fat is a combined focal length from the first lens unit L1 to the first intermediate lens unit Lmp1 at the telephoto end. BFw is an air-equivalent distance (back focus) on the optical axis from the lens surface closest to the image plane of the zoom lens L0 at the wide-angle end to the image plane, and f1 is a focal length of the first lens unit L1. mn1 is a moving amount of the first subsequent lens unit Lrn1 during zooming from the wide-angle end to the telephoto end, and Nave is an average value of the refractive index for the d-line of a glass material that is used for all the lenses included in all movable lens units configured to move during zooming.

Inequality (5) defines a proper relationship between the combined focal length of the subsequent group LR at the wide-angle end and the focal length of the first intermediate lens unit Lmp1. In a case where (−frw)/fp1 becomes higher than the upper limit of inequality (5), the power of the first intermediate lens unit Lmp1 increases, and it becomes difficult to correct longitudinal aberrations such as spherical aberration. In a case where (−frw)/fp1 becomes lower than the lower limit of inequality (5), the power of the subsequent group LR increases, and it becomes difficult to correct off-axial aberrations such as curvature of field.

The lower limit of inequality (5) may be set to 0.78, 0.83, 0.87, or 0.90. The upper limit of inequality (5) may be set to 9.00, 8.50, 8.00, or 7.50.

Inequality (6) defines a proper relationship between the combined focal length from the first lens unit L1 to the first intermediate lens unit Lmp1 at the telephoto end and the focal length of the zoom lens L0. In a case where fat/ft becomes higher than the upper limit of inequality (6), the composite power from the first lens unit L1 to the first intermediate lens unit Lmp1 decreases and the size of the zoom lens L0 increases. In a case where fat/ft becomes lower than the lower limit of inequality (6), the composite power increases and it becomes difficult to effectively correct aberrations, such as spherical aberration.

The lower limit of inequality (6) may be 0.75, 0.79, or 0.82. The upper limit of inequality (6) may be 1.40, 1.28, or 1.23.

Inequality (7) defines a proper relationship between the back focus of the zoom lens L0 at the wide-angle end and the focal length at the wide-angle end. In a case where BFw/fw becomes higher than the upper limit of inequality (7), the overall optical length of the zoom lens L0 increases. In a case where BFw/fw becomes lower than the lower limit of inequality (7), the flange back (a distance from a lens mount surface to the image plane in the image pickup apparatus) cannot be sufficiently secured, and it becomes difficult to place a shutter member and the like in the image pickup apparatus.

The lower limit of inequality (7) may be set to 0.52, 0.59, or 0.64. The upper limit of inequality (7) may be set to 1.33, 1.22, or 1.12.

Inequality (8) defines a proper relationship between the focal length of the first lens unit L1 and the focal length of the first intermediate lens unit Lmp1. In a case where (−f1)/fp1 becomes higher than the upper limit of inequality (8), the power of the first lens unit L1 decreases, and the outer diameter of the first lens unit Lmp1 increases as the angle of view increases. Alternatively, the power of the first intermediate lens unit Lmp1 increases, and it becomes difficult to correct on-axis aberrations such as spherical aberration. In a case where (−f1)/fp1 becomes lower than the lower limit of inequality (8), the power of the first lens unit L1 increases, and it becomes difficult to correct off-axis aberrations such as curvature of field that occurs in the first lens unit L1 as the angle of view increases. Alternatively, the power of the first intermediate lens unit Lmp1 decreases, and it becomes difficult to obtain the necessary magnification-varying ratio.

The lower limit of inequality (8) may be set to 0.61, 0.64, or 0.66. The upper limit of inequality (8) may be set to 2.10, 2.00, 1.34, or 1.00.

Inequality (9) defines a proper relationship between the moving amounts of the first intermediate lens unit Lmp1 and the first subsequent lens unit Lrn1 during zooming from the wide-angle end to the telephoto end. In a case where |mn1/mp1| becomes higher than the upper limit of inequality (9), the moving amount of the first subsequent lens unit Lrn1 increases, and suppression of aberration fluctuations such as curvature of field becomes insufficient. In a case where |mn1/mp1| becomes lower than the lower limit of inequality (9), the moving amount of the first intermediate lens unit Lmp1 increases, and suppression of aberration fluctuations such as spherical aberration becomes insufficient.

The lower limit of inequality (9) may be set to 0.34, 0.36, or 0.38. The upper limit of inequality (9) may be set to 0.71, 0.67, or 0.65.

Inequality (10) defines a proper average value of the refractive index of the glass material used in the movable lens unit configured to move during zooming. In a case where Nave becomes higher than the upper limit of inequality (10), the lenses constituting the movable lens unit become too sensitive to manufacturing errors, and it becomes difficult to suppress deterioration of optical performance due to manufacturing errors. In a case where Nave becomes lower than the lower limit of inequality (10), aberrations cannot be sufficiently corrected to achieve high optical performance.

The lower limit of inequality (10) may be set to 1.50, 1.52, 1.54, or 1.56. The upper limit of inequality (10) may be set to 1.77, 1.75, or 1.74.

Next follows a description of a specific configuration of the zoom lens L0 according to each example.

### Example 1

The zoom lens L0 according to Example 1 illustrated in FIG. 1 includes, in order from the object side to the image side, a first lens unit L1 with negative refractive power, a first intermediate lens unit Lmp1 with positive refractive power, a second intermediate lens unit Lmp2 with positive refractive power, a first subsequent lens unit Lrn1 with negative refractive power, and a final lens unit Lk with positive refractive power. The intermediate group LM includes the first intermediate lens unit Lmp1 and the second intermediate lens unit Lmp2, and the subsequent group LR includes the first subsequent lens unit Lrn1.

During zooming, the first lens unit L1 and the final lens unit Lk are stationary relative to the image plane IP. During zooming from the wide-angle end to the telephoto end, the first intermediate lens unit Lmp1, the second intermediate lens unit Lmp2, and the first subsequent lens unit Lrn1 move monotonically toward the object side. During focusing from infinity to a close distance, the first subsequent lens unit Lrn1 moves toward the image side. In order to reduce (correct) image blur, the second intermediate lens unit Lmp2 moves in a direction orthogonal to the optical axis (illustrated by an alternate long and short dash line in FIG. 1).

The first lens unit L1 includes a total of four lenses, or includes, in order from the object side to the image side, a first negative meniscus lens convex toward the object side, a second negative meniscus lens convex toward the object side, a biconcave negative lens, and a positive meniscus lens convex toward the object side.

The first intermediate lens unit Lmp1 includes a total of three lenses, or includes, in order from the object side to the image side, a biconvex positive lens with aspheric surfaces on both sides, a biconcave negative lens, disposed on the image side of the aperture stop SP, and a biconvex positive lens.

The second intermediate lens unit Lmp2 includes, in order from the object side to the image side, a positive cemented lens (two lenses in total) consisting of a negative meniscus lens convex toward the object side and a positive meniscus lens convex toward the object side.

The first subsequent lens unit Lrn1 includes a total of two lenses, or includes, in order from the object side to the image side, a negative meniscus lens convex toward the object side and a negative meniscus lens with aspheric surfaces on both sides and convex toward the image side. The final lens unit Lk includes a single lens as a positive meniscus lens convex toward the image side.

### Example 2

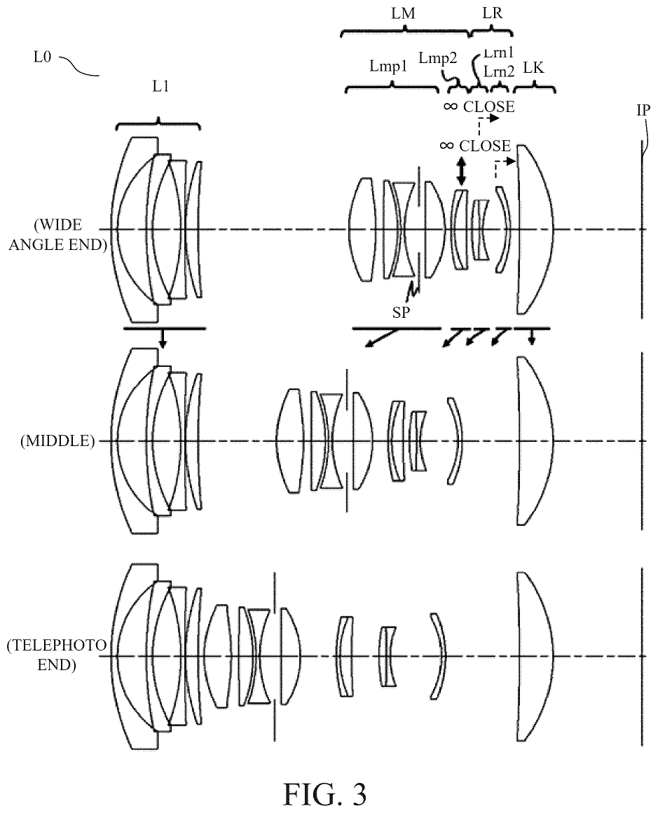

The zoom lens L0 according to Example 2 illustrated in FIG. 3 includes, in order from the object side to the image side, a first lens unit L1 with negative refractive power, a first intermediate lens unit Lmp1 with positive refractive power, a second intermediate lens unit Lmp2 with positive refractive power, a first subsequent lens unit Lrn1 with negative refractive power, a second subsequent lens unit Lrn2 with negative refractive power, and a final lens unit Lk with positive refractive power. The intermediate group LM includes the first intermediate lens unit Lmp1 and the second intermediate lens unit Lmp2, and the subsequent group LR includes the first subsequent lens unit Lrn1 and the second subsequent lens unit Lrn2.

During zooming, the first lens unit L1 and the final lens unit Lk are stationary relative to the image plane IP. During zooming from the wide-angle end to the telephoto end, the first intermediate lens unit Lmp1, the second intermediate lens unit Lmp2, the first subsequent lens unit Lrn1, and the second subsequent lens unit Lrn2 move monotonically toward the object side. During focusing from infinity to a close distance, the first subsequent lens unit Lrn1 and the second subsequent lens unit Lrn2 move toward the image side on different trajectories. In order to correct image blur, the second intermediate lens unit Lmp2 moves in a direction orthogonal to the optical axis.

The first lens unit L1 includes a total of four lenses, or includes, in order from the object side to the image side, a first negative meniscus lens with an aspheric surface on the image side and a convex shape toward the object side, a second negative meniscus lens convex toward the object side, a biconcave negative lens, and a positive meniscus lens convex toward the object side.

The first intermediate lens unit Lmp1 includes a total of four lenses, or includes, in order from the object side to the image side, a biconvex positive lens with aspheric surfaces on both sides, a biconvex positive lens, a biconcave negative lens, and a positive plano-convex lens disposed on the image side of the aperture stop SP, with an aspheric surface on the image side, and convex toward the image side.

The second intermediate lens unit Lmp2 includes a positive cemented lens (two lenses) in which a negative meniscus lens convex toward the object side and a positive meniscus lens convex toward the object side are cemented together.

The first subsequent lens unit Lrn1 includes a negative cemented lens (two lenses) in which a biconvex positive lens and a biconcave negative lens are cemented together and arranged in this order from the object side to the image side.

The second subsequent lens unit Lrn2 includes a single lens as a negative meniscus lens convex toward the image side.

The final lens unit Lk includes a single lens that is a positive meniscus lens convex toward the image side.

### Example 3

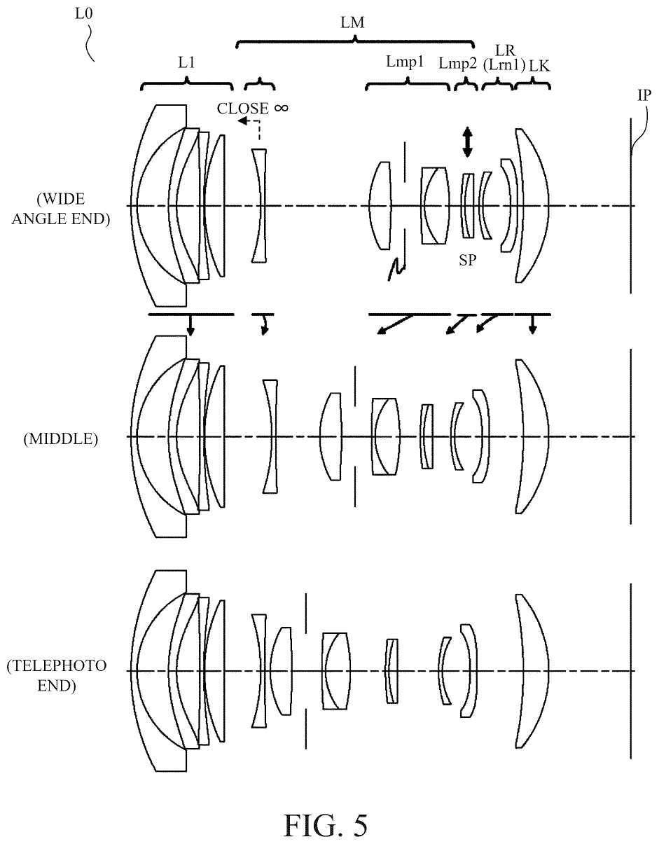

The zoom lens L0 according to Example 3 illustrated in FIG. 5 includes, in order from the object side to the image side, a first lens unit L1 with negative refractive power, an intermediate lens unit Lmn with negative refractive power, a first intermediate lens unit Lmp1 with positive refractive power, a second intermediate lens unit Lmp2 with positive refractive power, a first subsequent lens unit Lrn1 with negative refractive power, and a final lens unit Lk with positive refractive power. The intermediate group LM includes the intermediate lens unit Lmn, the first intermediate lens unit Lmp1, and the second intermediate lens unit Lmp2, and the subsequent group LR includes the first subsequent lens unit Lrn1.

During zooming, the first lens unit L1 and the final lens unit Lk are stationary relative to the image plane IP. During zooming from the wide-angle end to the intermediate zoom position, the intermediate lens unit Lmn moves monotonically toward the image side, and during zooming from the intermediate zoom position to the telephoto end, the intermediate lens unit Lmn moves monotonically toward the object side. During zooming from the wide-angle end to the telephoto end, the first intermediate lens unit Lmp1, the second intermediate lens unit Lmp2, and the first subsequent lens unit Lrn1 move monotonically toward the object side. During focusing from infinity to a close distance, the intermediate lens unit Lmn moves toward the object side. In order to correct image blur, the second intermediate lens unit Lmp2 moves in a direction orthogonal to the optical axis.

The first lens unit L1 includes a total of four lenses, or includes, in order from the object side to the image side, a first negative meniscus lens convex toward the object side, a second negative meniscus lens with aspheric surfaces on both sides and convex toward the object side, a biconcave negative lens, and a biconvex positive lens.

The intermediate lens unit Lmn includes a single lens that is a biconcave negative lens.

The first intermediate lens unit Lmp1 includes a total of three lenses, or includes, in order from the object side to the image side, a positive lens that is aspheric on both sides and has a biconvex shape, and a positive cemented lens (two lenses) disposed on the image side of the aperture stop SP and in which a negative meniscus lens that is convex toward the object side and a biconvex positive lens are cemented together.

The second intermediate lens unit Lmp2 includes a positive cemented lens (two lenses) in which a negative meniscus lens convex toward the object side and a positive meniscus lens convex toward the object side are cemented together and arranged in this order from the object side to the image side.

The first subsequent lens unit Lrn1 includes a total of two lenses, or includes, in order from the object side to the image side, a negative meniscus lens convex toward the object side and a negative meniscus lens with aspheric surfaces on both sides and convex toward the image side.

The final lens unit Lk includes a single lens that is a positive meniscus lens convex toward the image side.

### Example 4

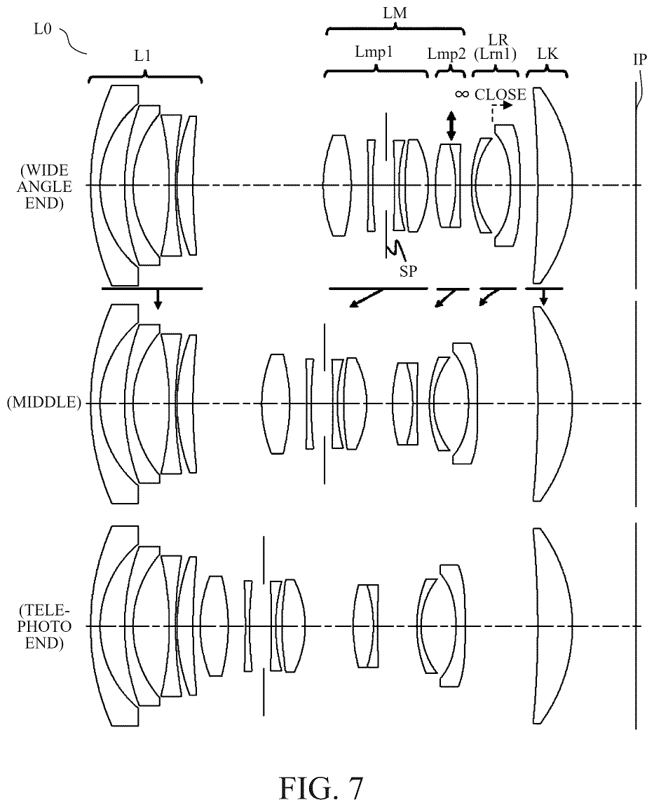

The zoom lens L0 according to Example 4 illustrated in FIG. 7 includes, in order from the object side to the image side, a first lens unit L1 with negative refractive power, a first intermediate lens unit Lmp1 with positive refractive power, a second intermediate lens unit Lmp2 with positive refractive power, a first subsequent lens unit Lrn1 with negative refractive power, and a final lens unit Lk with positive refractive power. The intermediate group LM includes the first intermediate lens unit Lmp1 and the second intermediate lens unit Lmp2, and the subsequent group LR includes the first subsequent lens unit Lrn1.

During zooming, the first lens unit L1 and the final lens unit Lk are stationary relative to the image plane IP. During zooming from the wide-angle end to the telephoto end, the first intermediate lens unit Lmp1, the second intermediate lens unit Lmp2, and the first subsequent lens unit Lrn1 move monotonically toward the object side. During focusing from infinity to a close distance, the first subsequent lens unit Lrn1 moves toward the image side. In order to correct image blur, the second intermediate lens unit Lmp2 moves in a direction orthogonal to the optical axis.

The first lens unit L1 includes a total of four lenses, or includes, in order from the object side to the image side, a first negative meniscus lens convex toward the object side, a second negative meniscus lens convex toward the object side, a biconcave negative lens, and a positive meniscus lens convex toward the object side.

The first intermediate lens unit Lmp1 includes a total of four lenses, or includes, in order from the object side to the image side, a biconvex positive lens with aspheric surfaces on both sides, a biconcave negative lens, a biconcave negative lens on the image side of the aperture stop SP, and a biconvex positive lens.

The second intermediate lens unit Lmp2 includes a positive cemented lens (two lenses) in which a biconvex positive lens and a biconcave negative lens are cemented together and arranged in this order from the object side to the image side.

The first subsequent lens unit Lrn1 includes a total of two lenses or includes, in order from the object side to the image side, a negative meniscus lens convex toward the object side, and a negative meniscus lens with aspheric surfaces on both sides and convex toward the image side.

The final lens unit Lk includes a single lens as a positive meniscus lens convex toward the image side.

### Example 5

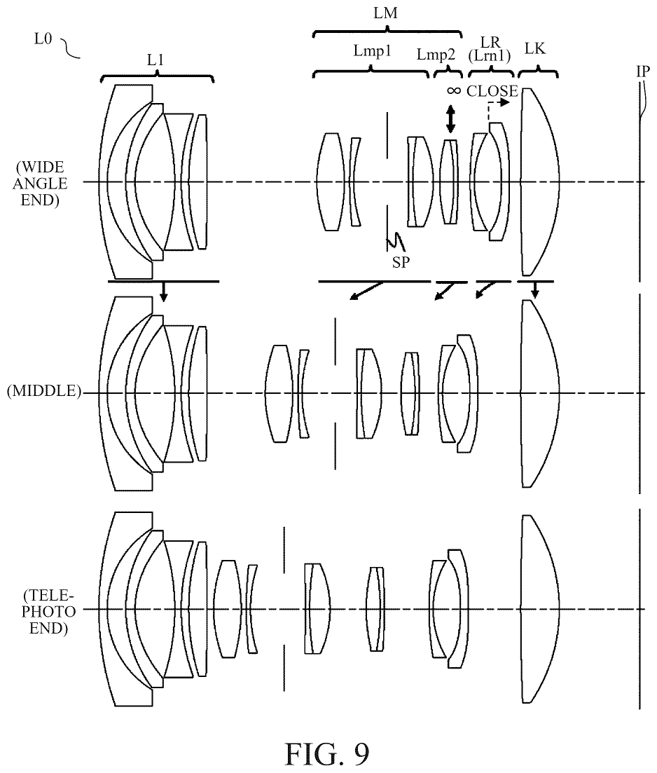

The zoom lens L0 according to Example 5 illustrated in FIG. 9 includes, in order from the object side to the image side, a first lens unit L1 with negative refractive power, a first intermediate lens unit Lmp1 with positive refractive power, a second intermediate lens unit Lmp2 with positive refractive power, a first subsequent lens unit Lrn1 with negative refractive power, and a final lens unit Lk with positive refractive power. The intermediate group LM includes the first intermediate lens unit Lmp1 and the second intermediate lens unit Lmp2, and the subsequent group LR includes the first subsequent lens unit Lrn1.

During zooming, the first lens unit L1 and the final lens unit Lk are stationary relative to the image plane IP. During zooming from the wide-angle end to the telephoto end, the first intermediate lens unit Lmp1, the second intermediate lens unit Lmp2, and the first subsequent lens unit Lrn1 move monotonically toward the object side. During focusing from infinity to a close distance, the first subsequent lens unit Lrn1 moves toward the image side. In order to correct image blur, the second intermediate lens unit Lmp2 moves in a direction orthogonal to the optical axis.

The first lens unit L1 includes a total of four lenses, or includes, in order from the object side to the image side, a first negative meniscus lens convex toward the object side, a second negative meniscus lens with an aspheric surface on the image side and convex toward the object side, a biconcave negative lens, and a biconvex positive lens.

The first intermediate lens unit Lmp1 includes a total of four lenses or includes, in order from the object side to the image side, a biconvex positive lens with aspheric surfaces on both sides, a negative meniscus lens convex toward the object side, and a positive cemented lens (two lenses) disposed on the image side of the aperture stop SP and in which a biconcave negative lens and a biconvex positive lens are cemented together.

The second intermediate lens unit Lmp2 includes a positive cemented lens (two lenses) in which a biconvex positive lens and a negative meniscus lens convex toward the image side are cemented together and arranged in this order from the object side to the image side.

The first subsequent lens unit Lrn1 includes a total of two lenses, or includes, in order from the object side to the image side, a negative meniscus lens convex toward the object side, and a negative meniscus lens with aspheric surfaces on both sides and convex toward the image side.

The final lens unit Lk includes a single lens that is a biconvex positive lens.

### Example 6

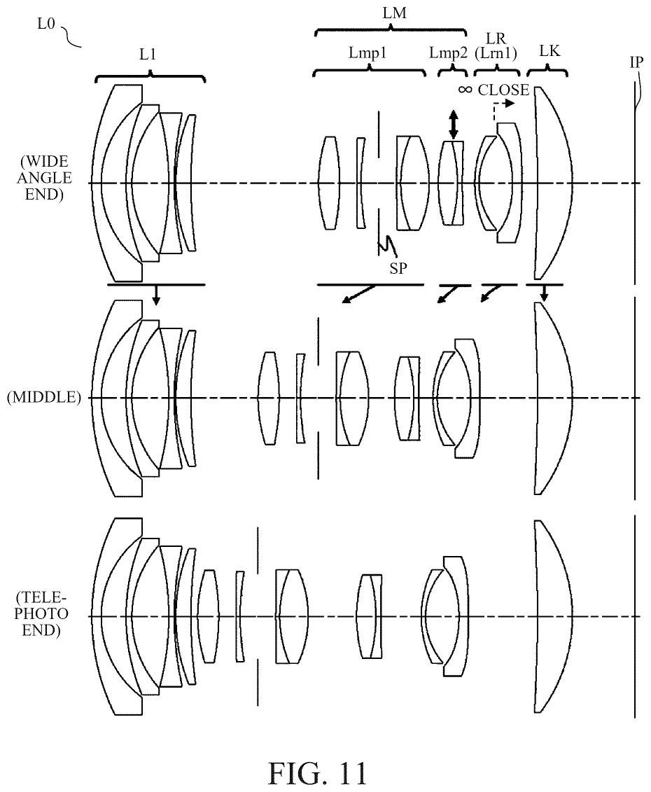

The zoom lens L0 according to Example 6 illustrated in FIG. 11 includes, in order from the object side to the image side, a first lens unit L1 with negative refractive power, a first intermediate lens unit Lmp1 with positive refractive power, a second intermediate lens unit Lmp2 with positive refractive power, a first subsequent lens unit Lrn1 with negative refractive power, and a final lens unit Lk with positive refractive power. The intermediate group LM includes the first intermediate lens unit Lmp1 and the second intermediate lens unit Lmp2, and the subsequent group LR includes the first subsequent lens unit Lrn1.

During zooming, the first lens unit L1 and the final lens unit Lk are stationary relative to the image plane IP. During zooming from the wide-angle end to the telephoto end, the first intermediate lens unit Lmp1, the second intermediate lens unit Lmp2, and the first subsequent lens unit Lrn1 move monotonically toward the object side. During focusing from infinity to a close distance, the first subsequent lens unit Lrn1 moves toward the image side. In order to correct image blur, the second intermediate lens unit Lmp2 moves in a direction orthogonal to the optical axis.

The first lens unit L1 includes a total of four lenses, or includes, in order from the object side to the image side, a first negative meniscus lens convex toward the object side, a second negative meniscus lens convex toward the object side, a biconcave negative lens, and a positive meniscus lens convex toward the object side.

The first intermediate lens unit Lmp1 includes a total of four lenses, or includes, in order from the object side to the image side, a biconvex positive lens with aspheric surfaces on both sides, a negative meniscus lens convex toward the object side, and a positive cemented lens (two lenses) disposed on the image side of the aperture stop SP, in which a negative meniscus lens and convex toward the object side and a biconvex positive lens are cemented together.

The second intermediate lens unit Lmp2 includes a total of two lenses. Alternatively, the second intermediate lens unit Lmp2 includes a positive cemented lens in which a biconvex positive lens and a biconcave negative lens are cemented together and arranged in this order from the object side to the image side.

The first subsequent lens unit Lrn1 includes a total of two lenses, or includes, in order from the object side to the image side, a negative meniscus lens convex toward the object side and a negative meniscus lens with aspheric surfaces on both sides and convex toward the image side.

The final lens unit Lk includes a single lens as a positive meniscus lens convex toward the image side.

### Example 7

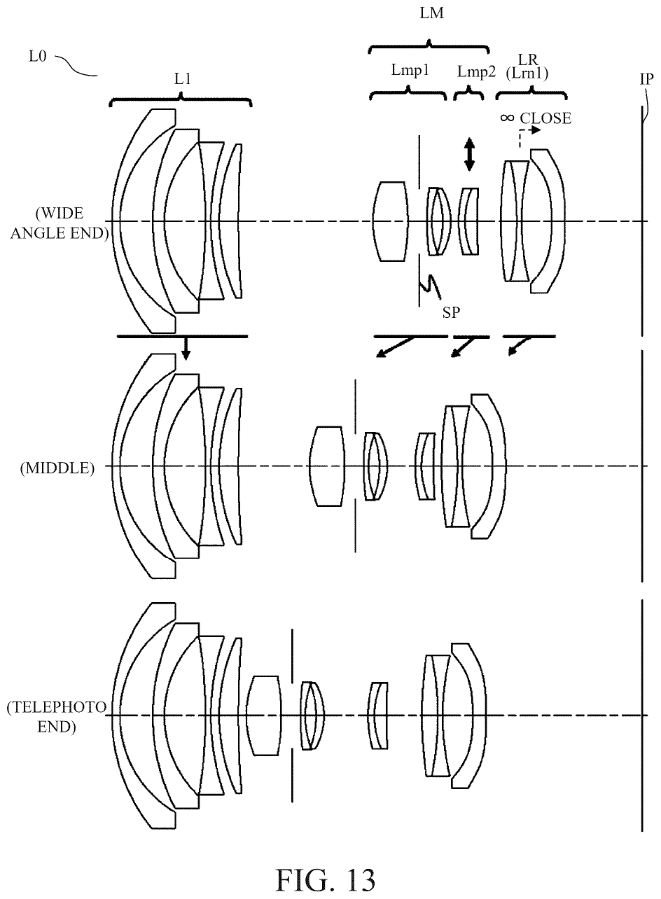

The zoom lens L0 according to Example 7 illustrated in FIG. 13 includes, in order from the object side to the image side, a first lens unit L1 with negative refractive power, a first intermediate lens unit Lmp1 with positive refractive power, a second intermediate lens unit Lmp2 with positive refractive power, and a first subsequent lens unit Lrn1 with negative refractive power. The intermediate group LM includes the first intermediate lens unit Lmp1 and the second intermediate lens unit Lmp2, and the subsequent group LR includes the first subsequent lens unit Lrn1.

During zooming, the first lens unit L1 is stationary relative to the image plane IP. During zooming from the wide-angle end to the telephoto end, the first intermediate lens unit Lmp1, the second intermediate lens unit Lmp2, and the first subsequent lens unit Lrn1 move monotonically toward the object side. During focusing from infinity to a close distance, the first subsequent lens unit Lrn1 moves toward the image side. In order to correct image blur, the second intermediate lens unit Lmp2 moves in a direction orthogonal to the optical axis.

The first lens unit L1 includes a total of four lenses, or includes, in order from the object side to the image side, a first negative meniscus lens convex toward the object side, a second negative meniscus lens convex toward the object side, a biconcave negative lens, and a positive meniscus lens convex toward the object side.

The first intermediate lens unit Lmp1 includes a total of three lenses, or includes, in order from the object side to the image side, a positive lens with aspheric surfaces on both sides and a biconvex shape, a negative meniscus lens with a convex shape toward the object side disposed on the image side of the aperture stop SP, and a positive meniscus lens convex toward the image side.

The second intermediate lens unit Lmp2 includes a positive cemented lens (two lenses) in which a negative meniscus lens convex toward the object side and a positive meniscus lens convex toward the object side are cemented together and arranged in this order from the object side to the image side.

The first subsequent lens unit Lrn1 includes a total of three lenses, or includes, in order from the object side to the image side, a negative cemented meniscus lens (two lenses) in which a biconvex positive lens and a biconcave negative lens are cemented together and arranged in this order from the object side to the image side, and a negative meniscus lens that is a plastic lens with aspheric surfaces on both sides and convex toward the image side.

Numerical examples 1 to 7 will be illustrated below. In surface data of each numerical example, a surface number m indicates the order of the surface when counted from the object side. r represents a radius of curvature of an m-th surface, d (mm) is a lens thickness or air gap (mm) on the optical axis between m-th and (m+1)-th surfaces, and nd is a refractive index for the d-line of the optical material between m-th and (m+1)-th surfaces. vd is an Abbe number based on the d-line of an optical material between m-th and (m+1)-th surfaces. The Abbe number vd based on the d-line is expressed as:

$$vd = ( Nd - 1 ) / ( NF - NC )$$

where Nd, NF, and NC are refractive indices for the d-line (587.6 nm), F-line (486.1 nm), and C-line (656.3 nm) in the Fraunhofer line.

A focal length (mm), F-number, and half angle of view) (°) are values when the zoom lens is in focus on an object at infinity. BF represents back focus (mm). The back focus is a distance on the optical axis from a lens surface closest to the image plane (final surface) of the zoom lens to the paraxial image surface, expressed as an air-equivalent length. An overall lens length is a distance on the optical axis from a lens surface closest to an object (front surface) of the zoom lens to the final surface plus the back focus, and corresponds to the overall optical length.

An asterisk “*” next to a surface number means that the surface has an aspheric shape. The aspheric shape is expressed by the following expression:

$$x = ( h 2 / R ) / [ 1 + \{ 1 - ( 1 + k ) ( h / R ) 2 \} 1 / 2 ] + A 4 \times h 4 + A 6 \times h 6 + A 8 \times h 8 + A 10 \times h 10 + A 12 \times h 12$$

where x is a displacement amount from a surface vertex in the optical axis direction, h is a height from the optical axis in a direction orthogonal to the optical axis, a light traveling direction is positive, R is a paraxial radius of curvature, K is a conic constant, and A4, A6, A8, A10, and A12 are aspheric coefficients. “e±Z” in the conic constant and aspheric coefficient means ×10±Z.

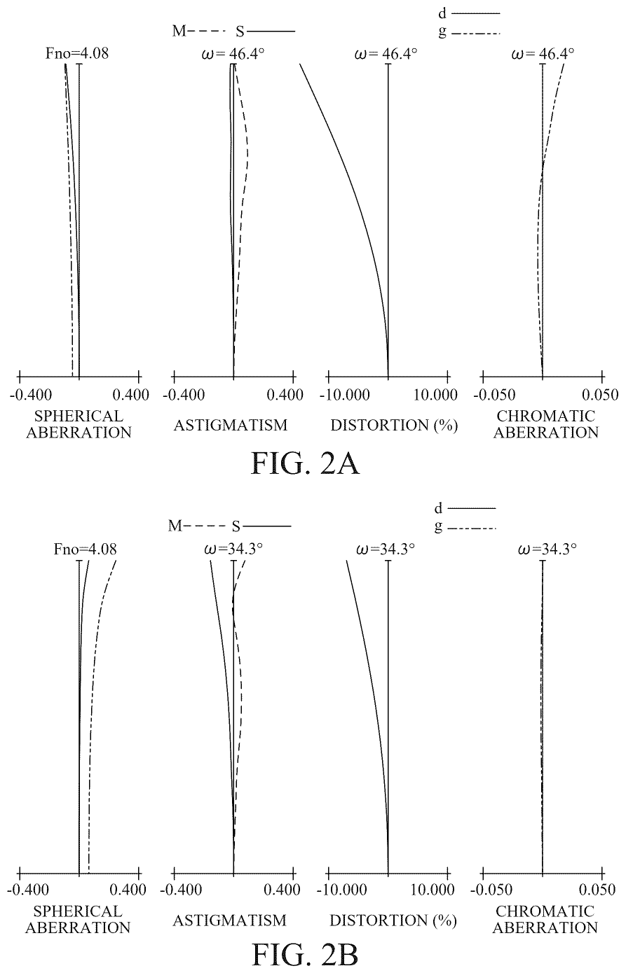

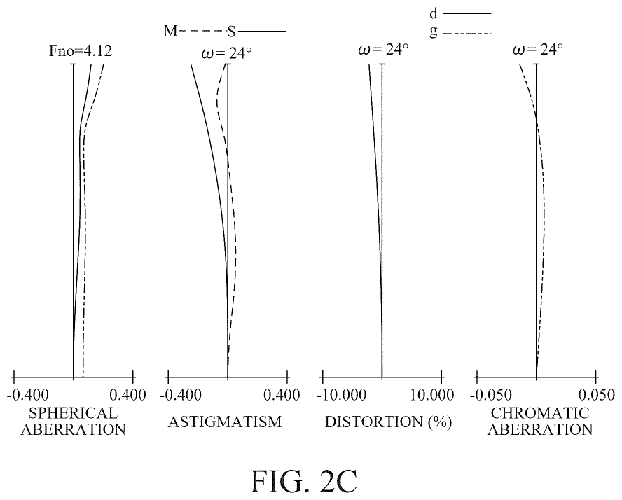

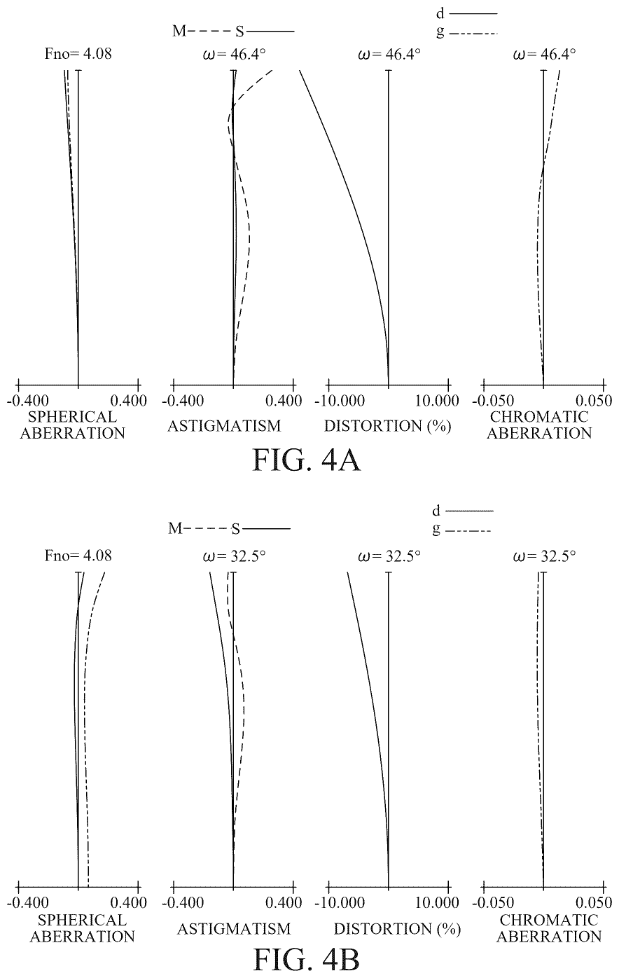

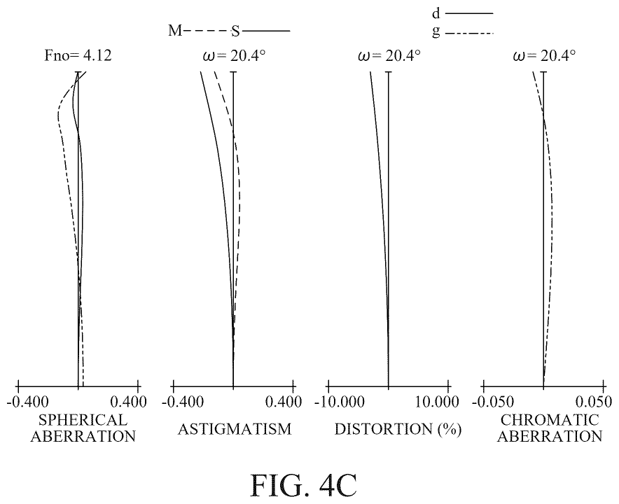

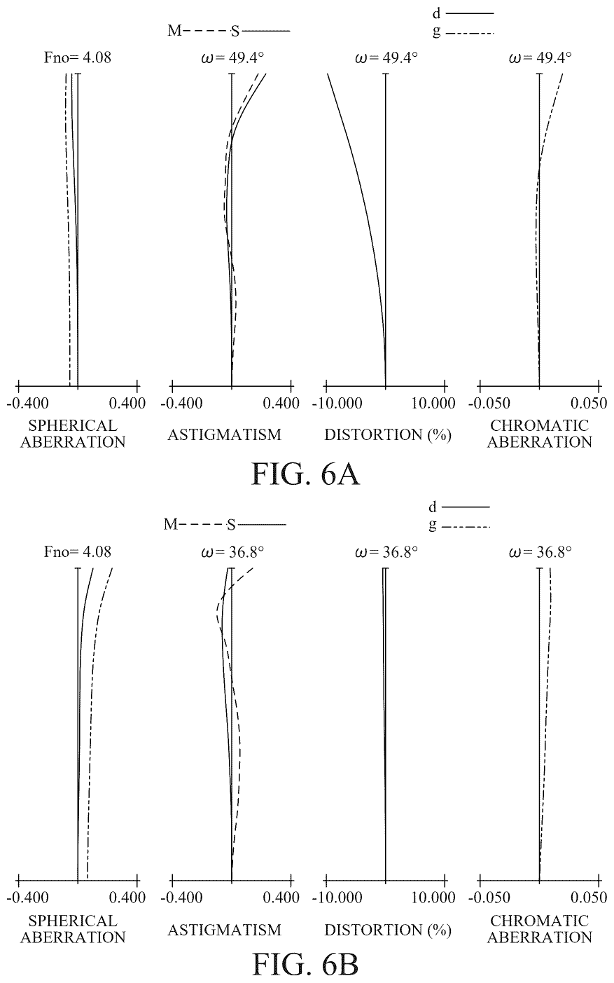

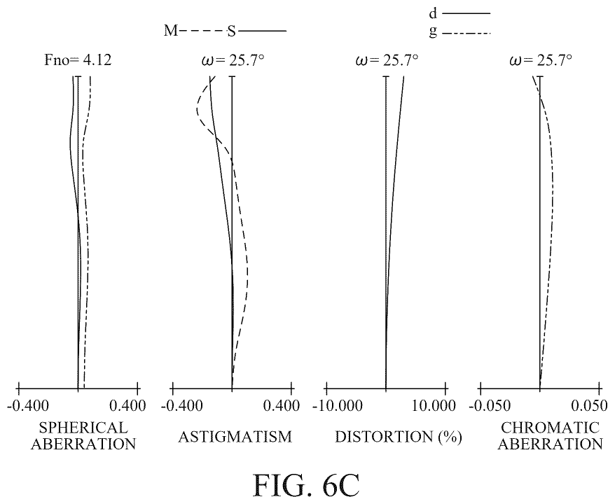

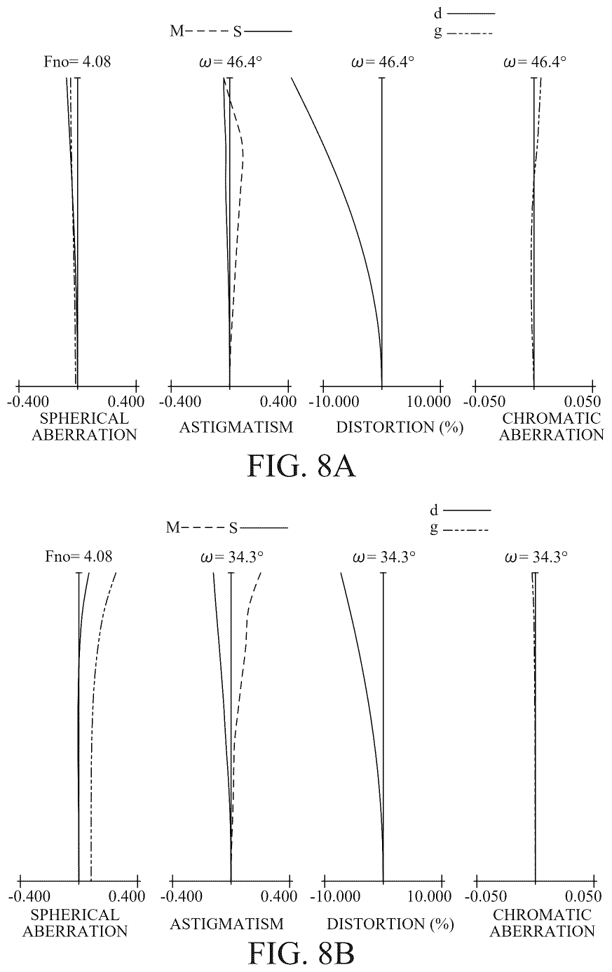

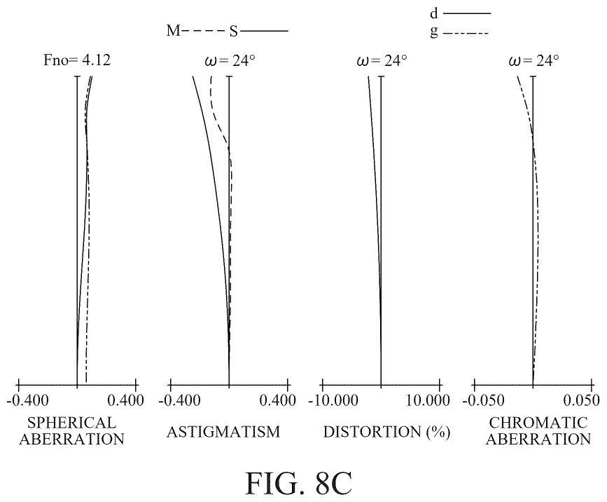

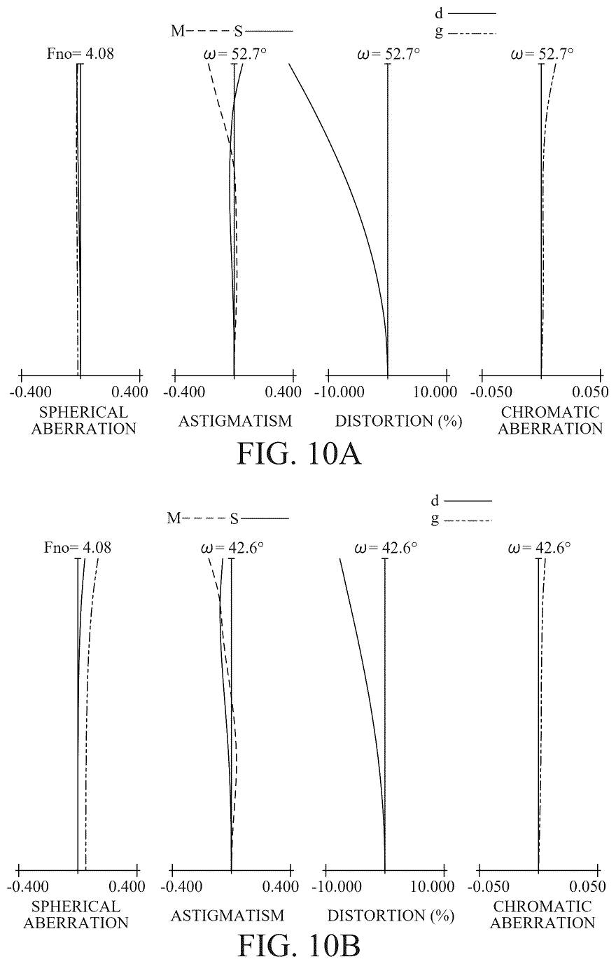

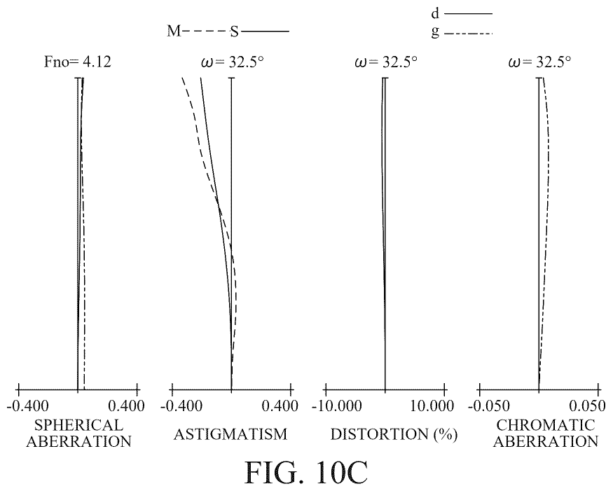

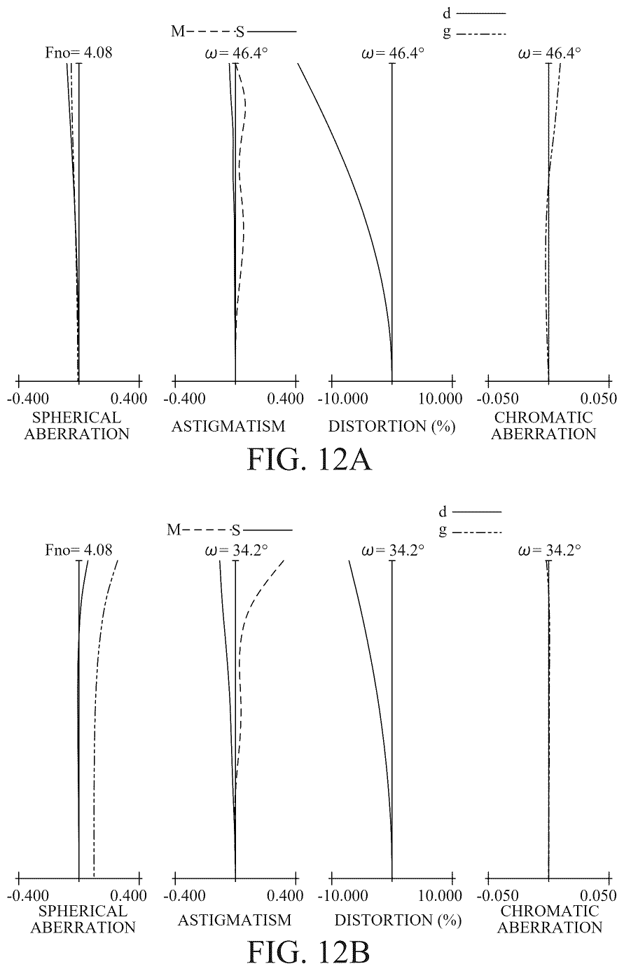

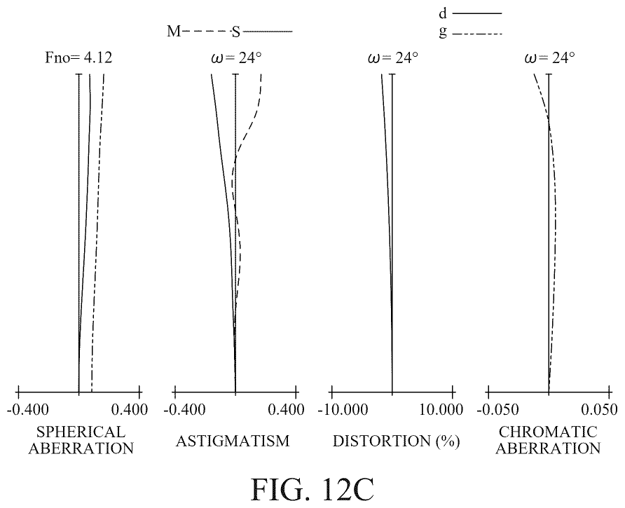

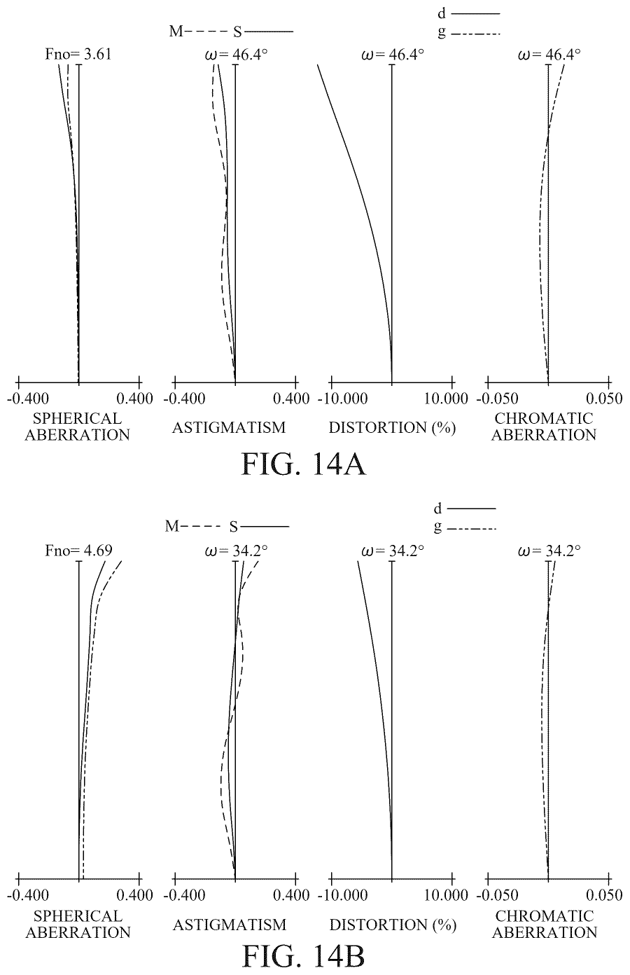

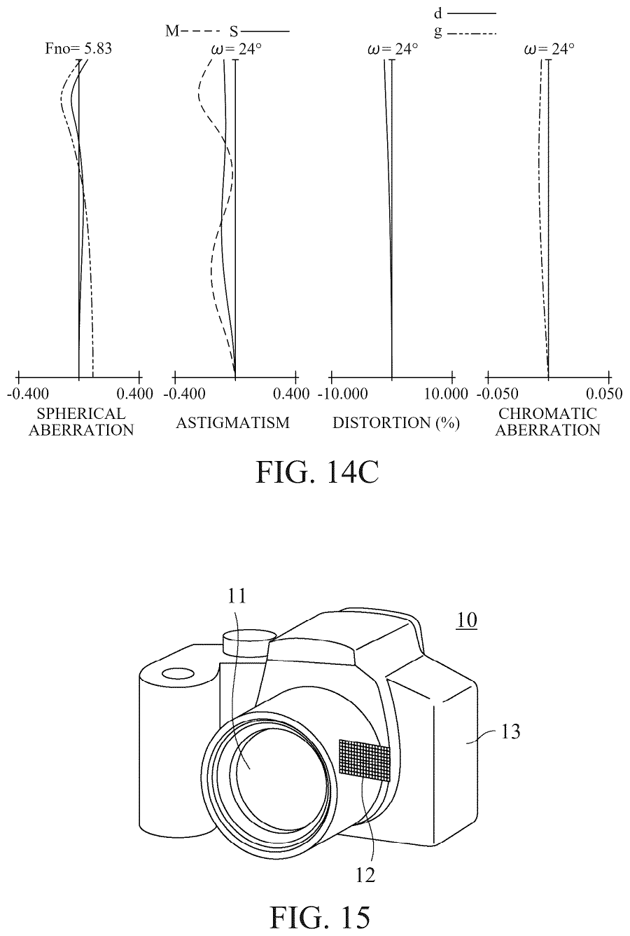

FIGS. 2A, 4A, 6A, 8A, 10A, 12A, and 14A respectively illustrate the longitudinal aberrations (spherical aberration, astigmatism, distortion, and chromatic aberration) of the zoom lens L0 according to numerical examples 1 to 7 at the wide-angle end in an in-focus state on an object at infinity. FIGS. 2B, 4B, 6B, 8B, 10B, 12B, and 14B respectively illustrate the longitudinal aberrations of the zoom lens L0 according to numerical examples 1 to 7 at the intermediate zoom position in an in-focus state on an object at infinity. FIGS. 2C, 4C, 6C, 8C, 10C, 12C, and 14C respectively illustrate the longitudinal aberrations of the zoom lens L0 according to numerical examples 1 to 7 at the telephoto end in an in-focus state on an object at infinity. In the spherical aberration diagram, Fno represents an F-number, a solid line indicates a spherical aberration amount for the d-line (wavelength 587.6 nm), and an alternate long and two short dashes line indicates a spherical aberration amount for the g-line (wavelength 435.8 nm). In the astigmatism diagram, a solid line S indicates an astigmatism amount on a sagittal image plane, and a dashed line M indicates an astigmatism amount on a meridional image plane. The distortion diagram illustrates a distortion amount for the d-line. The chromatic aberration diagram illustrates a lateral chromatic aberration amount for the g-line. ω is a half angle of view (°). WIDE means a wide-angle end, MIDDLE means an intermediate zoom position, and TELE means a telephoto end.

### Numerical Example 1

UNIT: mm
SURFACE DATA

| Surface No. | r | d | nd | νd |
|---|---|---|---|---|
| 1 | 48.788 | 2.00 | 1.80400 | 46.5 |
| 2 | 21.860 | 5.64 | | |
| 3 | 57.046 | 1.74 | 1.72916 | 54.7 |
| 4 | 23.770 | 7.35 | | |
| 5 | −54.146 | 1.36 | 1.49700 | 81.7 |
| 6 | 170.908 | 0.61 | | |
| 7 | 44.960 | 3.16 | 1.90110 | 27.1 |
| 8 | 171.520 | (Variable) | | |
| 9* | 23.768 | 6.51 | 1.58313 | 59.4 |
| 10* | −38.363 | 4.07 | | |
| 11 (SP) | ∞ | 2.16 | | |
| 12 | −64.016 | 0.90 | 1.73800 | 32.3 |
| 13 | 30.388 | 2.63 | | |
| 14 | 108.662 | 4.69 | 1.49700 | 81.7 |
| 15 | −20.020 | (Variable) | | |
| 16 | 26.181 | 1.05 | 1.72047 | 34.7 |
| 17 | 18.469 | 3.58 | 1.49700 | 81.7 |
| 18 | 118.593 | (Variable) | | |
| 19 | 24.431 | 1.20 | 1.80400 | 46.5 |
| 20 | 16.770 | 7.15 | | |
| 21* | −34.605 | 1.70 | 1.58313 | 59.4 |
| 22* | −990.655 | (Variable) | | |
| 23 | −168.002 | 7.73 | 1.67300 | 38.1 |
| 24 | −33.001 | 13.50 | | |
| Image Plane | ∞ | | | |

ASPHERIC DATA

9th Surface
K = 0.00000e+00 A 4 = −1.65323e−05 A 6 = −3.34095e−08
A 8 = 1.98795e−10 A10 = −3.25473e−12
10th Surface
K = 0.00000e+00 A 4 = 1.36050e−05 A 6 = −3.75284e−08
A 8 = 2.12565e−10 A10 = −3.23024e−12
21st Surface
K = 0.00000e+00 A 4 = −1.18164e−04 A 6 = 2.73264e−07
A 8 = −2.67312e−09 A10 = 8.38987e−12
22nd Surface
K = 0.00000e+00 A 4 = −9.89605e−05 A 6 = 3.76549e−07
A 8 = −1.73256e−09 A10 = 4.12838e−12

VARIOUS DATA
ZOOM RATIO 2.35

| | WIDE | MIDDLE | TELE |
|---|---|---|---|
| Focal Length | 20.60 | 31.67 | 48.50 |
| Fno | 4.08 | 4.08 | 4.12 |
| Half Angle of View (°) | 41.81 | 32.43 | 23.57 |
| Image Height | 18.43 | 20.12 | 21.16 |
| Overall Lens Length | 114.20 | 114.20 | 114.20 |
| BF | 13.50 | 13.50 | 13.50 |
| d8 | 27.74 | 14.95 | 2.17 |
| d15 | 1.55 | 5.01 | 9.40 |
| d18 | 2.45 | 2.55 | 7.77 |
| d22 | 3.74 | 12.97 | 16.15 |

LENS UNIT DATA

| Lens Unit | Starting Surface | Focal Length |
|---|---|---|
| 1 | 1 | −28.76 |
| 2 | 9 | 31.90 |
| 3 | 16 | 85.78 |
| 4 | 19 | −31.75 |
| 5 | 23 | 59.65 |

### Numerical Example 2

UNIT: mm
SURFACE DATA

| Surface No. | r | d | nd | νd |
|---|---|---|---|---|
| 1 | 51.999 | 1.50 | 1.76450 | 49.1 |
| 2* | 21.707 | 7.13 | | |
| 3 | 89.782 | 1.50 | 1.72916 | 54.7 |
| 4 | 33.747 | 6.96 | | |
| 5 | −46.940 | 1.00 | 1.43875 | 94.7 |
| 6 | 481.579 | 0.15 | | |
| 7 | 48.882 | 3.08 | 1.90110 | 27.1 |
| 8 | 172.633 | (Variable) | | |
| 9* | 25.608 | 6.60 | 1.58313 | 59.4 |
| 10* | −45.641 | 1.90 | | |
| 11 | 743.905 | 3.43 | 1.59282 | 68.6 |
| 12 | −32.695 | 0.78 | | |
| 13 | −33.591 | 0.90 | 1.67300 | 38.3 |
| 14 | 27.082 | 3.62 | | |
| 15 (SP) | ∞ | 1.50 | | |
| 16 | ∞ | 4.76 | 1.49700 | 81.7 |
| 17* | −22.237 | (Variable) | | |
| 18 | 39.639 | 0.90 | 1.85478 | 24.8 |
| 19 | 23.350 | 2.82 | 1.72916 | 54.7 |
| 20 | 153.745 | (Variable) | | |
| 21 | 38.314 | 1.79 | 1.92286 | 20.9 |
| 22 | −299.310 | 0.90 | 1.87400 | 35.3 |
| 23 | 18.641 | (Variable) | | |
| 24 | −19.345 | 1.00 | 1.85478 | 24.8 |
| 25 | −25.976 | (Variable) | | |
| 26 | −339.660 | 8.22 | 1.59282 | 68.6 |
| 27 | −33.588 | 21.75 | | |
| Image Plane | ∞ | | | |

ASPHERIC DATA

2nd Surface
K = 0.00000e+00 A 4 = 1.00150e−07 A 6 = −7.95946e−10
A 8 = −4.40810e−12 A10 = −4.57871e−15
9th Surface
K = 0.00000e+00 A 4 = −8.41099e−06 A 6 = −1.53412e−09
A 8 = 1.04408e−10
10th Surface
K = 0.00000e+00 A 4 = 2.26558e−05 A 6 = −1.07080e−08
A 8 = 2.06328e−10 A10 = −1.62470e−13
17th Surface
K = 0.00000e+00 A 4 = −4.76412e−06 A 6 = 2.31973e−09
A 8 = −1.06887e−10

VARIOUS DATA
ZOOM RATIO 2.83

| | WIDE | MIDDLE | TELE |
|---|---|---|---|
| Focal Length | 20.60 | 34.01 | 58.20 |
| Fno | 4.08 | 4.08 | 4.12 |
| Half Angle of View (°) | 41.80 | 30.66 | 19.84 |
| Image Height | 18.42 | 20.16 | 21.00 |
| Overall Lens Length | 130.00 | 130.00 | 130.00 |
| BF | 21.75 | 21.75 | 21.75 |
| d8 | 36.95 | 19.22 | 1.50 |
| d17 | 1.50 | 3.79 | 8.83 |
| d20 | 1.40 | 1.50 | 6.77 |
| d23 | 5.76 | 9.23 | 12.56 |
| d25 | 2.19 | 14.05 | 18.14 |

LENS UNIT DATA

| Lens Unit | Starting Surface | Focal Length |
|---|---|---|
| 1 | 1 | −32.14 |
| 2 | 9 | 33.97 |
| 3 | 18 | 85.67 |
| 4 | 21 | −47.52 |
| 5 | 24 | −95.28 |
| 6 | 26 | 62.25 |

### Numerical Example 3

UNIT: mm
SURFACE DATA

| Surface No. | r | d | nd | νd |
|---|---|---|---|---|
| 1 | 52.853 | 1.50 | 1.90043 | 37.4 |
| 2 | 21.652 | 7.89 | | |
| 3* | 40.227 | 2.00 | 1.85150 | 40.8 |
| 4* | 24.205 | 5.83 | | |
| 5 | −370.096 | 1.00 | 1.43875 | 94.7 |
| 6 | 119.211 | 0.15 | | |
| 7 | 40.885 | 5.00 | 1.85478 | 24.8 |
| 8 | −33712.149 | (Variable) | | |
| 9 | −45.230 | 1.00 | 1.59282 | 68.6 |
| 10 | 316.812 | (Variable) | | |
| 11* | 22.154 | 5.44 | 1.58313 | 59.4 |
| 12* | −90.332 | 3.43 | | |
| 13 (SP) | ∞ | 4.04 | | |
| 14 | 132.667 | 0.90 | 1.67300 | 38.1 |
| 15 | 14.796 | 6.18 | 1.49700 | 81.7 |
| 16 | −42.232 | (Variable) | | |
| 17 | 60.861 | 0.90 | 1.75520 | 27.5 |
| 18 | 27.836 | 2.14 | 1.81600 | 46.6 |
| 19 | 603.626 | (Variable) | | |
| 20 | 28.304 | 0.90 | 1.88300 | 40.8 |
| 21 | 16.595 | 6.96 | | |
| 22* | −45.236 | 1.70 | 1.58313 | 59.4 |
| 23* | −472.987 | (Variable) | | |
| 24 | −88.765 | 6.36 | 1.79952 | 42.2 |
| 25 | −30.003 | 20.55 | | |
| Image Plane | ∞ | | | |

ASPHERIC DATA

3rd Surface
K = 0.00000e+00 A 4 = −6.07335e−07 A 6 = −1.05195e−08
A 8 = −1.37728e−11
4th Surface
K = 0.00000e+00 A 4 = −9.75389e−06 A 6 = −2.82828e−08
A 8 = −5.36527e−11 A10 = 1.46783e−14
11th Surface
K = 0.00000e+00 A 4 = −6.09035e−06 A 6 = 6.82238e−08
A 8 = −8.03511e−10 A10 = 6.40376e−12
12th Surface
K = 0.00000e+00 A 4 = 1.58212e−05 A 6 = 6.93481e−08
A 8 = −8.12604e−10 A10 = 7.21631e−12
22nd Surface
K = 0.00000e+00 A 4 = −1.29529e−04 A 6 = 4.31087e−07
A 8 = −5.21282e−09
23rd Surface
K = 0.00000e+00 A 4 = −1.06295e−04 A 6 = 4.38325e−07
A 8 = −3.52857e−09 A10 = 6.32982e−12

VARIOUS DATA
ZOOM RATIO 2.35

| | WIDE | MIDDLE | TELE |
|---|---|---|---|
| Focal Length | 18.56 | 28.91 | 43.65 |
| Fno | 4.08 | 4.08 | 4.12 |
| Half Angle of View (°) | 46.44 | 36.66 | 26.37 |
| Image Height | 19.52 | 21.52 | 21.64 |
| Overall Lens Length | 125.00 | 125.00 | 125.00 |
| BF | 20.55 | 20.55 | 20.55 |
| d8 | 9.05 | 11.82 | 9.05 |
| d10 | 26.16 | 11.00 | 1.40 |
| d16 | 3.01 | 5.12 | 8.79 |
| d19 | 1.40 | 4.61 | 10.28 |
| d23 | 1.50 | 8.57 | 11.60 |

LENS UNIT DATA

| Lens Unit | Starting Surface | Focal Length |
|---|---|---|
| 1 | 1 | −58.43 |
| 2 | 9 | −66.70 |
| 3 | 11 | 29.28 |
| 4 | 17 | 75.42 |
| 5 | 20 | −29.09 |
| 6 | 24 | 54.09 |

### Numerical Example 4

UNIT: mm
SURFACE DATA

| Surface No. | r | d | nd | νd |
|---|---|---|---|---|
| 1 | 50.937 | 2.00 | 1.80400 | 46.5 |
| 2 | 22.411 | 5.21 | | |
| 3 | 47.167 | 1.75 | 1.72916 | 54.7 |
| 4 | 22.933 | 7.66 | | |
| 5 | −63.205 | 1.32 | 1.49700 | 81.7 |
| 6 | 84.858 | 0.32 | | |
| 7 | 40.385 | 3.39 | 1.90110 | 27.1 |
| 8 | 130.676 | (Variable) | | |
| 9* | 25.932 | 5.92 | 1.58313 | 59.4 |
| 10* | −37.163 | 3.65 | | |
| 11 | −233.055 | 0.90 | 1.85451 | 25.2 |
| 12 | 89.620 | 2.90 | | |
| 13 (SP) | ∞ | 1.71 | | |
| 14 | −188.407 | 0.90 | 1.65412 | 39.7 |
| 15 | 36.033 | 1.34 | | |
| 16 | 61.541 | 4.86 | 1.49700 | 81.7 |
| 17 | −21.416 | (Variable) | | |
| 18 | 33.132 | 4.25 | 1.49700 | 81.7 |
| 19 | −28.930 | 0.90 | 1.51742 | 52.4 |
| 20 | 245.654 | (Variable) | | |
| 21 | 25.961 | 0.90 | 1.51633 | 64.1 |
| 22 | 16.049 | 7.38 | | |
| 23* | −30.871 | 1.93 | 1.58313 | 59.4 |
| 24* | −998.588 | (Variable) | | |
| 25 | −212.830 | 7.33 | 1.69680 | 55.5 |
| 26 | −34.333 | 13.50 | | |
| Image Plane | ∞ | | | |

ASPHERIC DATA

9th Surface
K = 0.00000e+00 A 4 = −1.44546e−05 A 6 = −1.56206e−08
A 8 = 9.70937e−11 A10 = −7.94212e−13
10th Surface
K = 0.00000e+00 A 4 = 1.40293e−05 A 6 = −1.58162e−08
A 8 = 1.14711e−10 A10 = 7.86686e−13
23rd Surface
K = 0.00000e+00 A 4 = −8.33679e−05 A 6 = 1.44774e−07
A 8 = −2.15841e−09 A10 = 5.99141e−12
24th Surface
K = 0.00000e+00 A 4 = −6.76688e−05 A 6 = 2.20908e−07
A 8 = −1.24307e−09 A10 = 3.08199e−12

VARIOUS DATA
ZOOM RATIO 2.35

| | WIDE | MIDDLE | TELE |
|---|---|---|---|
| Focal Length | 20.60 | 31.72 | 48.50 |
| Fno | 4.08 | 4.08 | 4.12 |
| Half Angle of View (°) | 41.61 | 32.32 | 23.58 |
| Image Height | 18.30 | 20.07 | 21.17 |
| Overall Lens Length | 115.31 | 115.31 | 115.31 |
| BF | 13.50 | 13.50 | 13.50 |
| d8 | 27.50 | 14.50 | 1.50 |
| d17 | 1.55 | 5.49 | 10.16 |
| d20 | 2.45 | 2.62 | 8.28 |
| d24 | 3.78 | 12.67 | 15.34 |

LENS UNIT DATA

| Lens Unit | Starting Surface | Focal Length |
|---|---|---|
| 1 | 1 | −28.95 |
| 2 | 9 | 32.45 |
| 3 | 18 | 81.13 |
| 4 | 21 | −31.67 |
| 5 | 25 | 57.78 |

### Numerical Example 5

UNIT: mm
SURFACE DATA

| Surface No. | r | d | nd | νd |
|---|---|---|---|---|
| 1 | 62.531 | 1.80 | 1.90043 | 37.4 |
| 2 | 20.401 | 4.10 | | |
| 3 | 28.244 | 2.00 | 1.85400 | 40.4 |
| 4* | 19.228 | 8.66 | | |
| 5 | −47.773 | 1.40 | 1.49700 | 81.7 |
| 6 | 41.600 | 1.63 | | |
| 7 | 48.742 | 4.03 | 1.85478 | 24.8 |
| 8 | −442.453 | (Variable) | | |
| 9* | 26.797 | 6.02 | 1.58313 | 59.4 |
| 10* | −36.713 | 1.14 | | |
| 11 | 88.612 | 0.90 | 1.61340 | 44.3 |
| 12 | 30.696 | 7.29 | | |
| 13 (SP) | ∞ | 4.70 | | |
| 14 | −300.889 | 0.90 | 1.85478 | 24.8 |
| 15 | 60.940 | 4.46 | 1.49700 | 81.7 |
| 16 | −23.071 | (Variable) | | |
| 17 | 36.182 | 3.07 | 1.49700 | 81.7 |
| 18 | −49.365 | 0.90 | 1.77047 | 29.7 |
| 19 | −115.133 | (Variable) | | |
| 20 | 63.320 | 0.90 | 1.58913 | 61.1 |
| 21 | 20.981 | 5.95 | | |
| 22* | −57.451 | 1.70 | 1.76450 | 49.1 |
| 23* | −1000.000 | (Variable) | | |
| 24 | 509.234 | 8.40 | 1.65160 | 58.5 |
| 25 | −35.842 | 17.58 | | |
| Image Plane | ∞ | | | |

ASPHERIC DATA

4th Surface
K = 0.00000e+00 A 4 = −1.21568e−05 A 6 = −2.92679e−08
A 8 = 7.68953e−12 A10 = −2.98573e−13
9th Surface
K = 0.00000e+00 A 4 = −1.69030e−05 A 6 = −2.17045e−08
A 8 = 4.58570e−11 A10 = 6.58959e−14
10th Surface
K = 0.00000e+00 A 4 = 1.18029e−05 A 6 = −2.79384e−08
A 8 = 1.07697e−10 A10 = −1.90682e−13
22nd Surface
K = 0.00000e+00 A 4 = −1.26720e−04 A 6 = 3.72083e−07
A 8 = −1.50203e−09 A10 = −2.64021e−12
23rd Surface
K = 0.00000e+00 A 4 = −1.03004e−04 A 6 = 4.73481e−07
A 8 = −1.82251e−09 A10 = 3.33962e−12

VARIOUS DATA
ZOOM RATIO 2.06

| | WIDE | MIDDLE | TELE |
|---|---|---|---|
| Focal Length | 16.48 | 23.58 | 33.95 |
| Fno | 4.08 | 4.08 | 4.12 |
| Half Angle of View (°) | 47.56 | 40.29 | 32.40 |
| Image Height | 18.02 | 19.99 | 21.54 |
| Overall Lens Length | 118.00 | 118.00 | 118.00 |
| BF | 17.58 | 17.58 | 17.58 |
| d8 | 23.92 | 12.66 | 1.40 |
| d16 | 1.40 | 4.22 | 7.89 |
| d19 | 2.64 | 4.18 | 9.74 |
| d23 | 2.52 | 9.42 | 11.46 |

LENS UNIT DATA

| Lens Unit | Starting Surface | Focal Length |
|---|---|---|
| 1 | 1 | −21.85 |
| 2 | 9 | 32.37 |
| 3 | 17 | 67.44 |
| 4 | 20 | −30.80 |
| 5 | 24 | 51.70 |

### Numerical Example 6

UNIT: mm
SURFACE DATA

| Surface No. | r | d | nd | νd |
|---|---|---|---|---|
| 1 | 46.953 | 2.00 | 1.80400 | 46.5 |
| 2 | 21.356 | 5.35 | | |
| 3 | 42.819 | 1.25 | 1.61800 | 63.4 |
| 4 | 22.934 | 7.93 | | |
| 5 | −58.865 | 1.19 | 1.49700 | 81.7 |
| 6 | 65.541 | 0.31 | | |
| 7 | 38.855 | 3.27 | 1.90110 | 27.1 |
| 8 | 104.133 | (Variable) | | |
| 9* | 29.845 | 4.56 | 1.58313 | 59.4 |
| 10* | −44.171 | 3.70 | | |
| 11 | 446.638 | 0.90 | 1.76182 | 26.5 |
| 12 | 53.635 | 3.75 | | |
| 13 (SP) | ∞ | 3.91 | | |
| 14 | 800.000 | 0.85 | 1.61340 | 44.3 |
| 15 | 25.168 | 6.12 | 1.49700 | 81.7 |
| 16 | −24.238 | (Variable) | | |
| 17 | 32.742 | 4.13 | 1.49700 | 81.7 |
| 18 | −32.972 | 1.05 | 1.51742 | 52.4 |
| 19 | 191.981 | (Variable) | | |
| 20 | 23.012 | 0.90 | 1.51633 | 64.1 |
| 21 | 14.870 | 7.20 | | |
| 22* | −26.367 | 2.00 | 1.58313 | 59.4 |
| 23* | −300.000 | (Variable) | | |
| 24 | −322.629 | 7.53 | 1.65160 | 58.5 |
| 25 | −34.000 | 13.50 | | |
| Image Plane | ∞ | | | |

ASPHERIC DATA

9th Surface
K = 0.00000e+00 A 4 = −1.22200e−05 A 6 = −1.30528e−08
A 8 = 1.66705e−10 A10 = 1.61469e−14
10th Surface
K = 0.00000e+00 A 4 = 9.41880e−06 A 6 = −1.21827e−08
A 8 = 1.93208e−10
22nd Surface
K = 0.00000e+00 A 4 = −6.57431e−05 A 6 = 1.62758e−07
A 8 = 1.15618e−09 A10 = −8.17630e−11 A12 = 4.61761e−13
23rd Surface
K = 0.00000e+00 A 4 = −5.36868e−05 A 6 = 3.36296e−07
A 8 = −3.43301e−09 A10 = 1.01095e−11

VARIOUS DATA
ZOOM RATIO 2.35

| | WIDE | MIDDLE | TELE |
|---|---|---|---|
| Focal Length | 20.60 | 31.77 | 48.50 |
| Fno | 4.08 | 4.08 | 4.12 |
| Half Angle of View (°) | 41.54 | 32.30 | 23.66 |
| Image Height | 18.25 | 20.09 | 21.25 |
| Overall Lens Length | 116.79 | 116.79 | 116.79 |
| BF | 13.50 | 13.50 | 13.50 |
| d8 | 27.43 | 14.43 | 1.43 |
| d16 | 1.95 | 5.56 | 10.42 |
| d19 | 2.69 | 3.09 | 8.72 |
| d23 | 3.33 | 12.32 | 14.83 |

LENS UNIT DATA

| Lens Unit | Starting Surface | Focal Length |
|---|---|---|
| 1 | 1 | −28.28 |
| 2 | 9 | 32.51 |
| 3 | 17 | 83.12 |
| 4 | 20 | −29.98 |
| 5 | 24 | 57.73 |

### Numerical Example 7

UNIT: mm
SURFACE DATA

| Surface No. | r | d | nd | νd |
|---|---|---|---|---|
| 1 | 33.149 | 1.50 | 1.95375 | 32.3 |
| 2 | 20.747 | 6.16 | | |
| 3 | 37.514 | 2.20 | 1.91082 | 35.2 |
| 4 | 20.517 | 7.76 | | |
| 5 | −86.146 | 1.00 | 1.49700 | 81.7 |
| 6 | 44.315 | 1.58 | | |
| 7 | 34.512 | 3.58 | 1.85478 | 24.8 |
| 8 | 164.815 | (Variable) | | |
| 9* | 17.447 | 6.60 | 1.58313 | 59.4 |
| 10* | −35.367 | 2.08 | | |
| 11 (SP) | ∞ | 1.50 | | |
| 12 | 46.292 | 0.90 | 1.85451 | 25.2 |
| 13 | 16.328 | 2.07 | | |
| 14 | −16.613 | 1.47 | 1.49700 | 81.7 |
| 15 | −12.326 | (Variable) | | |
| 16 | 21.750 | 1.20 | 1.73800 | 32.3 |
| 17 | 15.280 | 2.28 | 1.49700 | 81.7 |
| 18 | 89.083 | (Variable) | | |
| 19 | 75.588 | 3.00 | 1.84666 | 23.9 |
| 20 | −54.732 | 0.90 | 1.95375 | 32.3 |
| 21 | 47.079 | 5.67 | | |
| 22* | −40.258 | 2.50 | 1.53504 | 55.7 |
| 23* | −90.102 | (Variable) | | |
| Image Plane | ∞ | | | |

ASPHERIC DATA

9th Surface
K = 0.00000e+00 A 4 = −4.03996e−05 A 6 = −1.61494e−07
A 8 = −1.09460e−09 A10 = −1.16939e−11
10th Surface
K = 0.00000e+00 A 4 = 2.15083e−05 A 6 = −1.76542e−07
A 8 = −1.96137e−09 A10 = 3.48352e−12
22nd Surface
K = 0.00000e+00 A 4 = −8.94279e−05 A 6 = −8.41145e−07
A 8 = 4.86754e−09
23rd Surface
K = 0.00000e+00 A 4 = −8.02127e−05 A 6 = −3.42404e−07
A 8 = 2.28946e−09 A10 = −6.59050e−13

VARIOUS DATA
ZOOM RATIO 2.35

| | WIDE | MIDDLE | TELE |
|---|---|---|---|
| Focal Length | 20.60 | 31.82 | 48.50 |
| Fno | 3.61 | 4.69 | 5.83 |
| Half Angle of View (°) | 42.64 | 32.68 | 23.77 |
| Image Height | 18.97 | 20.41 | 21.36 |
| Overall Lens Length | 99.74 | 99.74 | 99.74 |
| BF | 14.49 | 25.65 | 29.35 |
| d8 | 25.32 | 13.41 | 1.50 |
| d15 | 1.50 | 5.23 | 8.27 |
| d18 | 4.48 | 1.50 | 6.68 |
| d23 | 14.49 | 25.65 | 29.35 |

LENS UNIT DATA

| Lens Unit | Starting Surface | Focal Length |
|---|---|---|
| 1 | 1 | −31.31 |
| 2 | 9 | 31.46 |
| 3 | 16 | 75.54 |
| 4 | 19 | −55.82 |

Table 1 below summarizes values of inequalities (1) to (10) according to numerical examples 1 to 7. Numerical examples 1 to 7 satisfy all of inequalities (1) to (10).

TABLE 1

| | ex. 1 | ex. 2 | ex. 3 | ex. 4 | ex. 5 | ex. 6 | ex. 7 |
|---|---|---|---|---|---|---|---|
| fw | 20.600 | 20.600 | 18.560 | 20.600 | 16.478 | 20.600 | 20.600 |
| ft | 48.500 | 58.200 | 43.650 | 48.500 | 33.946 | 48.500 | 48.500 |
| f1 | −28.759 | −32.144 | −58.434 | −28.947 | −21.847 | −28.284 | −31.307 |
| fp1 | 31.898 | 33.972 | 29.282 | 32.448 | 32.374 | 32.508 | 31.464 |
| fp2 | 85.776 | 85.666 | 75.421 | 81.128 | 67.443 | 83.117 | 75.545 |
| frw | −31.750 | −31.170 | −29.088 | −31.668 | −30.799 | −29.979 | −55.823 |
| TTLW | 114.200 | 130.000 | 125.000 | 115.312 | 118.003 | 116.787 | 99.744 |
| BFw | 13.500 | 21.751 | 20.551 | 13.500 | 17.579 | 13.500 | 14.495 |
| mp1 | −25.574 | −35.448 | −24.760 | −26.000 | −22.523 | −26.000 | −23.823 |
| mp2 | −17.722 | −28.115 | −18.984 | −17.390 | −16.035 | −17.532 | −17.052 |
| mn1 | −12.406 | −22.741 | −10.104 | −11.557 | −8.942 | −11.498 | −14.852 |
| fat | 58.965 | 48.607 | 44.309 | 48.550 | 40.623 | 46.740 | 58.965 |
| Nave | 1.632 | 1.731 | 1.673 | 1.588 | 1.646 | 1.571 | 1.688 |
| ft/fw | 2.354 | 2.825 | 2.352 | 2.354 | 2.060 | 2.354 | 2.354 |
| \|mp2/mp1\| | 0.693 | 0.793 | 0.767 | 0.669 | 0.712 | 0.674 | 0.716 |
| \|mn1/mp1\| | 0.485 | 0.642 | 0.408 | 0.445 | 0.397 | 0.442 | 0.623 |
| fp2/fp1 | 2.689 | 2.522 | 2.576 | 2.500 | 2.083 | 2.557 | 2.401 |
| fat/ft | 1.216 | 0.835 | 1.015 | 1.001 | 1.197 | 0.964 | 1.216 |
| (−frw)/fp1 | 0.995 | 0.918 | 0.993 | 0.976 | 0.951 | 0.922 | 1.774 |
| (−f1)/fp1 | 0.902 | 0.946 | 1.996 | 0.892 | 0.675 | 0.870 | 0.995 |
| BFw/fw | 0.655 | 1.056 | 1.107 | 0.655 | 1.067 | 0.655 | 0.704 |
| TTLw/fw | 5.544 | 6.311 | 6.735 | 5.598 | 7.161 | 5.669 | 4.842 |

### Image Pickup Apparatus

FIG. 15 illustrates a digital still camera (image pickup apparatus) that uses the zoom lens L0 according to Examples 1 to 7 as an imaging optical system. Reference numeral 10 denotes a camera body, and reference numeral 11 denotes an imaging optical system that includes any one of the zoom lenses L0 according to Examples 1 to 7. Reference numeral 12 denotes an image sensor (photoelectric conversion element) such as a CCD sensor or CMOS sensor that is built into the camera body 10 and receives an optical image formed by the imaging optical system 11 and photoelectrically converts it (captures an object through the imaging optical system 11).

The camera body 10 may be a single-lens reflex camera with a quick-turn mirror, or a mirrorless camera with no quick-turn mirror.

Using the zoom lens L0 according to any one of examples as the image pickup apparatus in this way can provide an image pickup apparatus that has a reduced size and can provide a high-quality captured image.

### Imaging System

A surveillance camera may include as an imaging system (image pickup apparatus) that includes the zoom lens L0 according to Examples 1 to 7 and a control unit configured to control it. The control unit controls the movement of the magnification-varying lens unit, the focus lens unit, and the image stabilizing unit during zooming, focusing, and image stabilization of the zoom lens L0. The control unit may be built into the lens apparatus including the zoom lens L0, or may be configured separately from the lens apparatus so as to enable remote control of the zoom lens L0.

By connecting an operating member such as a button to the control unit, the control unit may control the zoom lens L0 according to a user operation to the operating unit. For example, the control unit may control the zoom lens L0 so that the focal length of the zoom lens L0 becomes longer when the user operates an enlargement button, and the focal length of the zoom lens L0 becomes shorter when the user operates a reduction button.

The imaging system may further include a display unit configured to display information on zooming of the zoom lens L0 (such as the zoom position). The information on the zooming is, for example, a zoom magnification, a focal length, and a position of a magnification-varying lens unit. The user can remotely operate the zoom lens L0 via the operation unit while viewing the information on the zooming displayed on the display unit. The operation unit also includes a touch panel provided on the display unit.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-118487, which was filed on Jul. 24, 2024, and Japanese Patent Application No. 2025-070523, which was filed on Apr. 22, 2025, which are hereby incorporated by reference herein in their entirety.

What is claimed is:

1. A zoom lens comprising, in order from an object side to an image side:
a first lens unit with negative refractive power;
an intermediate group with positive refractive power as a whole; and
a subsequent group with negative refractive power as a whole,
wherein the intermediate group includes:
a first intermediate lens unit with positive refractive power, and
a second intermediate lens unit with positive refractive power adjacent to and disposed on the image side of the first intermediate lens unit,
wherein during zooming, the first lens unit is stationary, and the first intermediate lens unit and the second intermediate lens unit move, and each distance between adjacent lens units changes,
wherein the first lens unit includes two or more lenses, and
wherein the following inequalities are satisfied:
$$0.1 \leq \vert mp 2 / mp 1 \vert \leq 0.82$$
$$1.23 \leq fp 2 / fp 1 \leq 10.$$
$$1. 50 \leq ft / fw \leq 6.00$$
$$0.1 \leq TTLw / fw \leq 10.00$$
where mp1 is a moving amount of the first intermediate lens unit during zooming from a wide-angle end to a telephoto end, mp2 is a moving amount of the second intermediate lens unit during zooming from the wide-angle end to the telephoto end, fp1 is a focal length of the first intermediate lens unit, fp2 is a focal length of the second intermediate lens unit, fw is a focal length of the zoom lens at the wide-angle end, ft is a focal length of the zoom lens at the telephoto end, and TTLw is a sum of a distance on an optical axis from a lens surface closest to an object of the zoom lens at the wide-angle end to a lens surface closest to an image plane of the zoom lens at the wide-angle end and an air-equivalent distance on the optical axis from a lens surface closest to the image plane of the zoom lens to the image plane.

2. The zoom lens according to claim 1, wherein a lens surface on the object side of a lens closest to the object of the subsequent group has a convex shape toward the object side.

3. The zoom lens according to claim 1, further comprising an aperture stop disposed on the object side of the second intermediate lens unit in the intermediate group.

4. The zoom lens according to claim 1, wherein the following inequality is satisfied:
$$0.73 \leq ( - frw ) / fp 1 \leq 2.04$$
where frw is a combined focal length of the subsequent group at the wide-angle end, and fp1 is a focal length of the first intermediate lens unit.

5. The zoom lens according to claim 1, wherein the subsequent group includes two or more lenses.

6. The zoom lens according to claim 5, wherein a biconvex air lens is formed between two adjacent lenses included in the subsequent group.

7. The zoom lens according to claim 1, wherein the first lens unit includes, in order from the object side to the image side, a first negative meniscus lens convex toward the object side and a second negative meniscus lens convex toward the object side.

8. The zoom lens according to claim 1, wherein the second intermediate lens unit includes a cemented lens in which a positive lens and a negative lens are cemented together.

9. The zoom lens according to claim 1, wherein during zooming from the wide-angle end to the telephoto end, all of the first intermediate lens unit, the second intermediate lens unit, and the subsequent group move toward the object side.

10. The zoom lens according to claim 1, wherein the following inequality is satisfied:
$$0.71 \leq fat / ft \leq 1.52$$
where fat is a combined focal length from the first lens unit to the first intermediate lens unit at the telephoto end.

11. The zoom lens according to claim 1, wherein the following inequality is satisfied:
$$0.46 \leq BFw / fw \leq 1.44$$
where BFw is an air-equivalent distance on an optical axis from the lens surface closest to the image plane of the zoom lens L0 at the wide-angle end to the image plane.

12. The zoom lens according to claim 1, wherein the following inequality is satisfied:
$$0.54 \leq ( - f 1 ) / fp 1 \leq 2.29$$
where f1 is a focal length of the first lens unit.

13. The zoom lens according to claim 1, wherein the subsequent group includes a first subsequent lens unit closest to the object, and
wherein the following inequality is satisfied:
$$0.32 \leq \vert mn 1 / mp 1 \vert \leq 0. 77$$
where mn1 is a moving amount of the first subsequent lens unit during zooming from the wide-angle end to the telephoto end.

14. The zoom lens according to claim 1, wherein the following inequality is satisfied:
$$1.45 \leq Nave \leq 1.8$$
where Nave is an average value of a refractive index for d-line of a glass material that is used for all lenses included in all movable lens units configured to move during zooming.

15. The zoom lens according to claim 1, wherein the first intermediate lens unit includes an aspheric lens with positive refractive power.

16. The zoom lens according to claim 1, wherein all lens units included in the subsequent group have negative refractive power.

17. The zoom lens according to claim 1, wherein the subsequent group is adjacent to and disposed on the image side of the second intermediate lens unit.

18. The zoom lens according to claim 1, wherein all lens units included in the subsequent group move toward the image side during focusing from infinity to a close distance.

19. The zoom lens according to claim 1, further comprising a final lens unit with positive refractive power on the image side of the subsequent group,
wherein the final lens unit is stationary during zooming.

20. The zoom lens according to claim 1, wherein all lens units in the zoom lens that move during zooming are electrically driven.

21. A zoom lens comprising, in order from an object side to an image side:
a first lens unit with negative refractive power;
an intermediate group with positive refractive power as a whole; and
a subsequent group with negative refractive power as a whole,
wherein the intermediate group includes:
a first intermediate lens unit with positive refractive power, and
a second intermediate lens unit with positive refractive power adjacent to and disposed on the image side of the first intermediate lens unit,
wherein during zooming, the first lens unit is stationary, the first intermediate lens unit and the second intermediate lens unit move, and each distance between adjacent lens units changes,
wherein the first lens unit includes three or more lenses, and
wherein the following inequality is satisfied:
$$1.5 \leq ft / fw \leq 6.00$$
where fw is a focal length of the zoom lens at a wide-angle end, and ft is a focal length of the zoom lens at a telephoto end.

22. A zoom lens comprising, in order from an object side to an image side:
a first lens unit with negative refractive power;
an intermediate group with positive refractive power as a whole; and
a subsequent group with negative refractive power as a whole,
wherein the intermediate group includes:
a first intermediate lens unit with positive refractive power, and
a second intermediate lens unit with positive refractive power adjacent to and disposed on the image side of the first intermediate lens unit,
wherein during zooming, the first lens unit is stationary, and the first intermediate lens unit and the second intermediate lens unit move, and each distance between adjacent lens units changes,
wherein the first lens unit includes two or more lens elements, and
wherein the following inequalities are satisfied:
$$0.1 \leq \vert mp 2 / mp 1 \vert \leq 0.82$$
$$1.23 \leq fp 2 / fp 1 \leq 10.$$
$$1. 50 \leq ft / fw \leq 6.00$$
$$0.1 \leq TTLw / fw \leq 10.00$$
where mp1 is a moving amount of the first intermediate lens unit during zooming from a wide-angle end to a telephoto end, mp2 is a moving amount of the second intermediate lens unit during zooming from the wide-angle end to the telephoto end, fp1 is a focal length of the first intermediate lens unit, fp2 is a focal length of the second intermediate lens unit, fw is a focal length of the zoom lens at the wide-angle end, ft is a focal length of the zoom lens at the telephoto end, and TTLw is a sum of a distance on an optical axis from a lens surface closest to an object of the zoom lens at the wide-angle end to a lens surface closest to an image plane of the zoom lens at the wide-angle end and an air-equivalent distance on the optical axis from a lens surface closest to the image plane of the zoom lens to the image plane.

23. An image pickup apparatus comprising:
the zoom lens according to claim 1; and
an image sensor configured to image an object through the zoom lens.
